(19) United States
(12) Patent Application Publication
(10) Pub. No.: US 2025/0313656 A1
(43) Pub. Date: Oct. 9, 2025

(54) METHOD FOR PRODUCING POLYOLEFIN SHEET AND ULTRA-HIGH MOLECULAR WEIGHT POLYETHYLENE SHEET

(71) Applicants: HIROSAKI UNIVERSITY, Hirosaki-shi, Aomori (JP); NATIONAL UNIVERSITY CORPORATION GUNMA UNIVERSITY, Maebashi-shi, Gunma (JP)

(72) Inventors: Daisuke Takeuchi, Hirosaki-shi, Aomori (JP); Moeka Narasaki, Hirosaki-shi, Aomori (JP); Hiroki Uehara, Maebashi-shi, Gunma (JP); Masaki Kakiage, Maebashi-shi, Gunma (JP); Ayaka Takazawa, Maebashi-shi, Gunma (JP)

(21) Appl. No.: 18/866,273

(22) PCT Filed: May 18, 2023
(86) PCT No.: PCT/JP2023/018656

§ 371 Date: Mar. 5, 2025

(30) Foreign Application Priority Data
May 19, 2022 (JP) 2022-082564

(51) Int. Cl. C08F 10/02; C08F 2/06; C08F 4/64; C08J 5/18

(52) U.S. Cl. CPC C08F 10/02; C08F 2/06; C08F 4/64; C08J 5/18; C08J 2323/06

(57) ABSTRACT

A method for producing a polyolefin sheet, the method including a step A of applying an organic solvent containing a metal catalyst onto an inner wall surface of a container, and a step B of synthesizing a polyolefin on the inner wall surface of the container by introducing an olefin monomer into the container, in which the organic solvent containing a metal catalyst has been applied onto the inner wall surface, wherein, in the step A, the organic solvent containing a metal catalyst is applied onto the inner wall surface of the container by moving the container, and an ultra-high molecular weight polyethylene sheet.

### TECHNICAL FIELD

The present disclosure relates to a method for producing a polyolefin sheet and an ultra-high molecular weight polyethylene sheet.

### BACKGROUND ART

Conventionally, methods such as a slurry method, a gas phase method, and a solution method are known as methods for synthesizing polyethylene by ethylene polymerization (see, for example, “Polyethylene Technology Handbook”, written and edited by Kazuo Matsuura and Naotaka Mikami, Kogyo Chosakai Publishing Co., Ltd., 2001).

The slurry method is a method of polymerizing ethylene by blowing ethylene gas into a solvent containing a catalyst while stirring the solvent, in which polyethylene is deposited in the solvent. According to the slurry method, polyethylene can be obtained as a powder. The gas phase method is a method of polymerizing ethylene by charging catalyst particles into a polymerization container containing ethylene gas, in which polyethylene is generated around the catalyst particles. According to the gas phase method, powdery polyethylene can be obtained in the same manner as in the slurry method. The solution method is a method of polymerizing ethylene by reacting ethylene at a high temperature using a solvent containing a catalyst, in which the polymerization of ethylene progresses in a state in which the polyethylene is dissolved in the solvent.

In recent years, ultra-high molecular weight polyethylene sheets to be used for various applications have been developed.

An ultra-high molecular weight polyethylene, which is a raw material for an ultra-high molecular weight polyethylene sheet, is typically synthesized using a slurry method. For example, the solution method has a restriction in that since the viscosity of the solution is increased by dissolving the polyethylene in the solvent, the molecular weight of the polyethylene is difficult to be increased, whereas the slurry method does not have such a restriction and is effective in that the molecular weight of the polyethylene can be increased by increasing the reaction time.

Generally, the ultra-high molecular weight polyethylene sheet has been produced by a method involving at least a step of synthesizing a powdery ultra-high molecular weight polyethylene by a slurry method and a step of stretching the powdery ultra-high molecular weight polyethylene.

Meanwhile, a method has also been reported in which an ultra-high molecular weight polyethylene sheet is produced with a small number of steps by carrying out film formation directly in the synthesis process of the ultra-high molecular weight polyethylene (see, for example, “H. Chanzy, A. Day, R. H. Marchessault, Polymer, 1967, 8, 567-588.”, “P. Smith, H. Chanzy, B. Rotzinger, Polymer Communications, 1985, 26, 258-260.”, and “P. Smith, H. Chanzy, B. Rotzinger, Journal of Materials Science, 1987, 22, 523-531.”). In the method described in “H. Chanzy, A. Day, R. H. Marchessault, Polymer, 1967, 8, 567-588.”, “P. Smith, H. Chanzy, B. Rotzinger, Polymer Communications, 1985, 26, 258-260.”, and “P. Smith, H. Chanzy, B. Rotzinger, Journal of Materials Science, 1987, 22, 523-531.”, a glass having a vanadium (III) chloride crystal adhering to the surface is produced by applying a heptane solution of vanadium (IV) chloride, which is a metal catalyst, onto the surface of the glass, and then a heptane solution of triisobutylaluminum, which is a co-catalyst, is brought into contact with the surface of the glass, and then an ethylene gas is blown thereonto, whereby an ultra-high molecular weight polyethylene sheet is formed on the surface of the glass.

### SUMMARY OF INVENTION

### Technical Problem

Although the production method described in “H. Chanzy, A. Day, R. H. Marchessault, Polymer, 1967, 8, 567-588.”, “P. Smith, H. Chanzy, B. Rotzinger, Polymer Communications, 1985, 26, 258-260.”, and “P. Smith, H. Chanzy, B. Rotzinger, Journal of Materials Science, 1987, 22, 523-531.” can efficiently produce the ultra-high molecular weight polyethylene sheet, the production method has problems in that, for example, when producing a sheet having a large area, use of a glass plate having the same size as the area is necessary; the metal catalyst that can be used is limited to vanadium (IV) chloride; and the film thickness of the obtained sheet is relatively small.

Under such circumstances, development of a new method for producing a polyethylene sheet in place of a conventional method is required. The present disclosure has been made in view of the above circumstances.

An object to be achieved by an embodiment of the present disclosure is to provide a method for producing a polyolefin sheet, in which it is possible to efficiently produce a self-supporting polyolefin film.

An object to be achieved by another embodiment of the present disclosure is to provide an ultra-high molecular weight polyethylene sheet having a high tear strength.

### Solution to Problem

Specific means for achieving the above objects include the following embodiments.

<1> A method for producing a polyolefin sheet, the method comprising:
a step A of applying an organic solvent containing a metal catalyst onto an inner wall surface of a container; and
a step B of synthesizing a polyolefin on the inner wall surface of the container by introducing an olefin monomer into the container, in which the organic solvent containing a metal catalyst has been applied onto the inner wall surface,
wherein, in the step A, the organic solvent containing a metal catalyst is applied onto the inner wall surface of the container by moving the container.

<2> The method for producing a polyolefin sheet according to <1>, wherein, in the step A, the organic solvent containing a metal catalyst is applied onto the inner wall surface of the container by rotating the container.

<3> The method for producing a polyolefin sheet according to <1> or <2>, wherein the metal catalyst is at least one selected from the group consisting of metallocene complexes, phenoxyimine titanium complexes, phenoxyimine zirconium complexes, phenoxyimine hafnium complexes, cyclopentadienylquinolyl chromium complexes, diimine palladium complexes, diimine nickel complexes, bisiminopyridine iron complexes, and bisiminopyridine cobalt complexes.

<4> The method for producing a polyolefin sheet according to any one of <1> to <3>, wherein the organic solvent containing a metal catalyst further contains a co-catalyst.

<5> The method for producing a polyolefin sheet according to <4>, wherein the co-catalyst is at least one selected from the group consisting of an alkylaluminoxane, a dialkylaluminum chloride, a trialkylaluminum/triphenylmethylium tetrakis(pentafluorophenyl)borate, a trialkylaluminum/N,N-dimethylanilinium tetrakis(pentafluorophenyl)borate, a trialkylaluminum/tris(pentafluorophenyl)borane, and sodium tetrakis (3,5-bis(trifluoromethyl)phenyl)borate.

<6> The method for producing a polyolefin sheet according to any one of <1> to <4>, wherein, a viscosity at 20° C. of the organic solvent containing a metal catalyst is 0.1 mPa·s or more but 10,000 mPa·s or less.

<7> The method for producing a polyolefin sheet according to any one of <1> to <6>, wherein, in the step B, the olefin monomer is introduced in a gas or liquid state.

<8> The method for producing a polyolefin sheet according to any one of <1> to <7>, wherein the olefin monomer is at least one selected from the group consisting of ethylene, propylene, 1-butene, 1-pentene, 1-hexene, 1-octene, 1-nonene, 1-decene, 4-methyl-1-pentene, cyclopentene, norbornene, styrene, vinylcyclohexane, allylcyclohexane, 4-cyclohexyl-1-butene, 5-cyclohexyl-1-pentene, 6-cyclohexyl-1-hexene, and tert-butylethylene.

<9> The method for producing a polyolefin sheet according to any one of <1> to <8>, wherein, in the step B, as the olefin monomer, a monomer containing ethylene in an amount of 50 mass % or more with respect to a total mass of the monomer is introduced into the container, in which the organic solvent containing a metal catalyst has been applied onto the inner wall surface, thereby synthesizing, on the inner wall surface of the container, an ultra-high molecular weight polyethylene having a weight average molecular weight of 500,000 or more estimated from a molecular weight distribution curve of a contained polyethylene obtained by carrying out a gel permeation chromatography measurement at 150° C. using 1,2,4-trichlorobenzene as an eluent.

<10> An ultra-high molecular weight polyethylene sheet, comprising an ultra-high molecular weight polyethylene in an amount of 50 mass % or more with respect to a total mass of the ultra-high molecular weight polyethylene sheet, the ultra-high molecular weight polyethylene having a weight average molecular weight of 500,000 or more estimated from a molecular weight distribution curve of a contained polyethylene obtained by carrying out a gel permeation chromatography measurement at 150° C. using 1,2,4-trichlorobenzene as an eluent, wherein:
the ultra-high molecular weight polyethylene sheet has only one melting peak in a measurement by a differential scanning calorimeter;
a temperature of the melting peak is 138° C. or more but less than 145° C.; and
a crystallinity calculated by dividing a melting heat obtained from an area of the melting peak by a melting heat of a polyethylene perfect crystal is 65% or more.

<11> The ultra-high molecular weight polyethylene sheet according to <10>, wherein a molecular weight distribution index of the ultra-high molecular weight polyethylene is 5 or less.

<12> The ultra-high molecular weight polyethylene sheet according to <10> or <11>, wherein a degree of orientation estimated from an orthorhombic (110) reflection intensity of a diffraction image obtained by normal incident X-rays on a sheet surface is 50% or less.

<13> The ultra-high molecular weight polyethylene sheet according to any one of <10> to <12>, wherein a tear strength is 20 N/mm or more.

<14> The ultra-high molecular weight polyethylene sheet according to any one of <10> to <13>, wherein a water contact angle at 25° C. is 100° or more.

<15> The ultra-high molecular weight polyethylene sheet according to any one of <10> to <14>, wherein, when heated at 140° C. for 10 minutes, an absolute value of a dimensional change rate in a parallel direction with respect to a sheet surface is less than 20%.

### Advantageous Effects of Invention

According to an embodiment of the present disclosure, there is provided a method for producing a polyolefin sheet, in which it is possible to efficiently produce a self-supporting polyolefin film.

According to another embodiment of the present disclosure, there is provided an ultra-high molecular weight polyethylene sheet having a high tear strength.

### BRIEF DESCRIPTION OF DRAWINGS

FIG. 1A is a DSC curve of the sheet 1 obtained by Production Example 1.

FIG. 1B is a DSC curve of the sheet 2 obtained by Production Example 2.

FIG. 1C is a DSC curve of the sheet 11 obtained by Production Example 11.

FIG. 2A is a DSC curve of the sheet 13 obtained by Production Example 13.

FIG. 2B is a DSC curve of the sheet 14 obtained by Production Example 14.

FIG. 2C is a DSC curve of the sheet 15 obtained by Production Example 15.

FIG. 3 is WAXD images of the sheet 1 obtained by Production Example 1, the sheet 2 obtained by Production Example 2, the sheet 11 obtained by Production Example 11, the sheet 13 obtained by Production Example 13, the sheet 14 obtained by Production Example 14, and the sheet 15 obtained by Production Example 15.

FIG. 4 is a graph showing an azimuthal angle profile of the sheet 13 obtained by Production Example 13.

FIG. 5 is SEM images after platinum palladium vapor deposition coating of the sheet 1 obtained by Production Example 1, the sheet 2 obtained by Production Example 2, the sheet 11 obtained by Production Example 11, the sheet 13 obtained by Production Example 13, the sheet 14 obtained by Production Example 14, and the sheet 15 obtained by Production Example 15.

### DESCRIPTION OF EMBODIMENTS

Hereinafter, a method for producing a polyolefin sheet and an ultra-high molecular weight polyethylene sheet according to the present disclosure are described in detail. Although the description of the requirements described below may be carried out based on the representative embodiments of the present disclosure, the present disclosure is not limited to such embodiments, and can be implemented with appropriate modifications within the scope of the purpose of the present disclosure.

In the present disclosure, the numerical range indicated by using “to” means a range including the numerical values described before and after the “to” as a lower limit value and an upper limit value, respectively.

Regarding the numerical range described stepwise in the present disclosure, the upper limit value or the lower limit value described in a certain numerical range may be replaced with the upper limit value or the lower limit value of another numerical range described stepwise. Further, regarding the numerical range described in the present disclosure, the upper limit value or the lower limit value described in a certain numerical range may be replaced with the value shown in the Examples.

In the present disclosure, in the case of referring to the amount of each component in the application liquid for forming the polyolefin sheet or the ultra-high molecular weight polyethylene sheet, when there are plural substances corresponding to each component in the application liquid, the amount means the total amount of the plural substances present in the application liquid unless otherwise specified.

In the present disclosure, the combination of two or more preferred embodiments is more preferable.

In the present disclosure, the term “step” encompasses not only an independent step but also a step that cannot be clearly distinguished from other steps, as long as the expected purpose of the step is achieved.

In the present disclosure, the “self-supporting film” means a film that can maintain a shape as a film even if there is no support.

### Method for Producing Polyolefin Sheet

A method for producing a polyolefin sheet according to the present disclosure (hereinafter also referred to as a “production method according to the present disclosure”) includes:
a step A of applying an organic solvent containing a metal catalyst onto an inner wall surface of a container; and
a step B of synthesizing a polyolefin on the inner wall surface of the container by introducing an olefin monomer into the container, in which the organic solvent containing a metal catalyst has been applied onto the inner wall surface.

According to the production method according to the present disclosure, a self-supporting polyolefin film can be efficiently produced.

### Step A

Step A is a step of applying an organic solvent containing a metal catalyst onto an inner wall surface of a container.

In the present disclosure, an organic solvent containing a metal catalyst is also referred to as a “sheet-forming application liquid”.

The sheet-forming application liquid contains a metal catalyst.

The type of the metal catalyst is not particularly limited.

Examples of the metal catalyst include metal complexes such as metallocene complexes, phenoxyimine titanium complexes, phenoxyimine zirconium complexes, phenoxyimine hafnium complexes, cyclopentadienylquinolyl chromium complexes, diimine palladium complexes, diimine nickel complexes, bisiminopyridine iron complexes, and bisiminopyridine cobalt complexes.

The metal catalyst is preferably at least one selected from the group consisting of metallocene complexes, phenoxyimine titanium complexes, phenoxyimine zirconium complexes, phenoxyimine hafnium complexes, cyclopentadienylquinolyl chromium complexes, diimine palladium complexes, diimine nickel complexes, bisiminopyridine iron complexes, and bisiminopyridine cobalt complexes, more preferably at least one selected from the group consisting of phenoxyimine titanium complexes and metallocene complexes, and still more preferably a metallocene complex.

The metallocene complex is a complex having a conjugated carbon 5-membered ring containing a metal element.

The metal element is not particularly limited, and is, for example, preferably a Group 4 transition metal element of the periodic table, more preferably hafnium, zirconium, or titanium, and still more preferably titanium.

A complex having a conjugated carbon 5-membered ring is not particularly limited, but generally a complex having a substituted or unsubstituted cyclopentadienyl ligand is used.

As the metallocene complex, for example, a hafnocene derivative, a titanocene derivative, and a zirconocene derivative may also be used. Here, the “derivative” refers to one having an arbitrary substituent on a carbon atom of a metallocene conjugated carbon 5-membered ring. The number of substituents is not limited. In this regard, one having two conjugated carbon 5-membered rings connected to each other via a substituent may also be included.

Specific examples of the metallocene complex include bis(cyclopentadienyl)hafnium (IV) dichloride, bis (cyclopentadienyl)zirconium (IV) dichloride, bis(cyclopentadienyl)titanium (IV) dichloride, bis(propylcyclopentadienyl)hafnium (IV) dichloride, bis(pentamethylcyclopentadienyl)zirconium (IV) dichloride, bis(butylcyclopentadienyl)hafnium (IV) dichloride, [dimethylbis(cyclopentadienyl)silyl]zirconium (IV) dichloride, bis(dodecylcyclopentadienyl)zirconium (IV) dichloride, bis(trimethylsilylcyclopentadienyl)zirconium (IV) dichloride, bis(tetrahydroindenyl)zirconium (IV) dichloride, (ethylidene-bisindenyl)zirconium (IV) dichloride, ethylidenebis(tetrahydroindenyl)zirconium (IV) dichloride, bis[3,3-(2-methyl-benzindenyl)]dimethylsilanediylzirconium (IV) dichloride, cyclopentadienyltitanium (IV) trichloride, pentamethylcyclopentadienyltitanium (IV) trichloride, (ethylidene-bisindenyl)titanium (IV) dichloride, and ethylidenebis(tetrahydroindenyl)titanium (IV) dichloride.

The sheet-forming application liquid may contain only one metal catalyst, or may contain two or more kinds of metal catalysts.

The concentration of the metal catalyst in the sheet-forming application liquid is not particularly limited, and is, for example, preferably from 0.000001 mol/L (liter; hereinafter, the same applies) to 0.1 mol/L, more preferably from 0.00001 mol/L to 0.01 mol/L, and still more preferably from 0.0001 mol/L to 0.005 mol/L.

The sheet-forming application liquid contains an organic solvent.

The type of the organic solvent is not particularly limited.

Examples of the organic solvent include toluene, xylene, hexane, heptane, decalin, methylene chloride, dichloroethane, tetrachloroethane, chlorobenzene, dichlorobenzene, trichlorobenzene, polyethylene glycol, oligoethylene glycol, polydimethylsiloxane, and oligodimethylsiloxane.

As the organic solvent, at least one selected from toluene or hexane is preferable, and toluene is more preferable.

The viscosity of the organic solvent is not particularly limited, and is, for example, preferably 0.1 mPa·s or more but less than 100,000 mPa·s, more preferably 0.1 mPa·s or more but less than 10,000 mPa·s, and still more preferably 0.1 mPa·s or more but less than 1,000 mPa·s.

When the viscosity of the organic solvent is within the above range, the sheet-forming application liquid tends to be more satisfactorily applied onto the inner wall surface of the container.

In the present disclosure, the viscosity of the organic solvent means a viscosity at 20° C. and is a value measured using a vibration type viscometer. As the vibration type viscometer, for example, a vibration type viscometer (model number: VM-10A) manufactured by SEKONIC CORPORATION can be suitably used. However, the vibration type viscometer is not limited thereto.

For example, in a case where the sheet-forming application liquid contains a co-catalyst described below, it is preferable that the organic solvent is dehydrated from the viewpoint of suppressing decomposition of the co-catalyst due to moisture.

The sheet-forming application liquid may contain only one organic solvent, or may contain two or more types of organic solvents.

The content of the organic solvent in the sheet-forming application liquid is not particularly limited, and is, for example, preferably from 60 mass % to 99.99 mass %, more preferably from 70 mass % to 99.9 mass %, and still more preferably from 80 mass % to 99 mass %, with respect to the total mass of the sheet-forming application liquid.

The sheet-forming application liquid preferably further contains a co-catalyst.

The type of the co-catalyst is not particularly limited.

Examples of the co-catalyst include an alkylaluminoxane, a dialkylaluminum chloride, a trialkylaluminum/triphenylmethylium tetrakis(pentafluorophenyl)borate, a trialkylaluminum/N,N-dimethylanilinium tetrakis(pentafluorophenyl)borate, a trialkylaluminum/tris(pentafluorophenyl)borane, and sodium tetrakis(3,5-bis(trifluoromethyl)phenyl)borate.

The co-catalyst is preferably at least one selected from the group consisting of an alkylaluminoxane, a dialkylaluminum chloride, a trialkylaluminum/triphenylmethylium tetrakis(pentafluorophenyl)borate, a trialkylaluminum/N,N-dimethylanilinium tetrakis(pentafluorophenyl)borate, a trialkylaluminum/tris(pentafluorophenyl)borane, and sodium tetrakis (3,5-bis(trifluoromethyl)phenyl)borate, and more preferably an alkylaluminoxane.

The number of carbon atoms in the alkyl moiety of the alkylaluminoxane is not particularly limited, and is, for example, preferably from 1 to 8, and more preferably from 1 to 4.

Specific examples of the alkylaluminoxane include methylaluminoxane, ethylaluminoxane, and isobutylaluminoxane.

The alkylaluminoxane is preferably methylaluminoxane (MAO).

Examples of a commercially available product of methylaluminoxane include “TMAO-212 (product name)” and “MMAO-3A (product name)” manufactured by Tosoh Finechem Corporation, and “MAO (product name)” manufactured by Sigma-Aldrich. In the present disclosure, the co-catalyst serves a function of improving the viscosity of the sheet-forming application liquid in addition to the original co-catalyst function of improving the catalytic action of the metal catalyst.

In general, the co-catalyst may also function as a so-called thickener because of its high viscosity. Therefore, when the sheet-forming application liquid contains a co-catalyst, not only the catalytic action of the metal catalyst is improved but also the sheet-forming application liquid can be satisfactorily applied onto the inner wall surface of the container owing to thickening of the sheet-forming application liquid, so that a self-supporting polyolefin film can be more efficiently produced. From such a viewpoint, the co-catalyst is preferably a solid co-catalyst, which is likely to increase the viscosity of the sheet-forming application liquid.

Examples of solid co-catalysts include methylaluminoxane (MAO).

When the sheet-forming application liquid further contains a co-catalyst, only one co-catalyst may be contained, or two or more types of co-catalysts may be contained.

When the sheet-forming application liquid further contains a co-catalyst, the content of the co-catalyst in the sheet-forming application liquid is not particularly limited.

For example, when the sheet-forming application liquid contains an alkylaluminoxane [preferably methylaluminoxane (MAO)] as a co-catalyst, the content of the co-catalyst in the sheet-forming application liquid may be such an amount that the aluminum content (moles) in the co-catalyst is preferably from 10 times to 50,000 times, more preferably from 50 times to 10,000 times, and still more preferably from 100 times to 5,000 times the content (moles) of the metal catalyst.

An embodiment in which the sheet-forming application liquid contains a metal catalyst and an organic solvent, the metal catalyst is a metallocene complex, and the organic solvent is at least one selected from the group consisting of toluene and hexane is preferable; an embodiment in which the sheet-forming application liquid contains a metal catalyst, a co-catalyst, and an organic solvent, the metal catalyst is a metallocene complex, the organic solvent is at least one selected from the group consisting of toluene and hexane, and the co-catalyst is an alkylaluminoxane is more preferable; and an embodiment in which the sheet-forming application liquid contains a metal catalyst, a co-catalyst, and an organic solvent, the metal catalyst is a metallocene complex, the organic solvent is at least one selected from the group consisting of toluene and hexane, and the co-catalyst is methylaluminoxane (MAO) is still more preferable.

The viscosity of the sheet-forming application liquid is not particularly limited, and is, for example, preferably 0.1 mPa·s or more but 10,000 mPa·s or less, more preferably 0.4 mPa·s or more but 10,000 mPa·s or less, and still more preferably 0.4 mPa·s or more but 1,000 mPa·s or less.

When the viscosity of the sheet-forming application liquid is within the above range, the sheet-forming application liquid tends to be more satisfactorily applied onto the inner wall surface of the container.

In the present disclosure, the viscosity of the sheet-forming application liquid means a viscosity at 20° C. and is a value measured using a vibration type viscometer. As the vibration type viscometer, for example, a vibration type viscometer (model number: VM-10A) manufactured by SEKONIC CORPORATION can be suitably used. However, the vibration type viscometer is not limited thereto.

The appearance shape of the container is not particularly limited, and may be, for example, a tube shape (for example, a round tube shape, a square tube shape, or the like), a spherical shape, or the like. When the appearance shape of the container is a tube shape, the shape of the cross section perpendicular to the longitudinal direction of the tube may be circular, semicircular, elliptical, rectangular, square, trapezoidal, or the like.

In this regard, the appearance shape of the container may also be a semiround tube shape.

The container may be one in which a part of the wall is opened, or may be sealed.

Further, the container may be a long hollow tube, and the long hollow tube may be helically wound.

The shape of the inner wall surface of the container is not particularly limited as long as the film can be formed.

The shape of the inner wall surface of the container may be, for example, a flat surface or a curved surface.

The shape of the inner wall surface of the container may also be helical.

When at least a portion of the shape of the inner wall surface of the container is helical, for example, continuous production of the polyolefin sheet can be achieved by rotating the container.

The material of the container is not particularly limited, and may be, for example, glass, metal, or resin.

Examples of the metal include stainless steel (so-called SUS), chromium steel, aluminum, titanium, and the like.

Examples of the resin include engineering plastics such as fluororesin, polyimide, polyether ether ketone, aramid, polyphenylene sulfide, and polyamide.

The container may be made of glass, may be made of metal, or may be made of resin.

The container may also be composed of two or more kinds of materials selected from the group consisting of glass, metal, and resin.

From the viewpoint of improving the wettability of the sheet-forming application liquid, the inner wall surface of the container may be subjected to a surface treatment such as a corona discharge treatment or a plasma discharge treatment.

When the wettability of the sheet-forming application liquid on the inner wall surface of the container is improved, a self-supporting polyolefin film can be more satisfactorily produced.

The size of the container is not particularly limited, and can be set, as appropriate, in accordance with the size of the target polyolefin sheet, for example.

The method of applying the sheet-forming application liquid onto the inner wall surface of the container is not particularly limited, and for example, may be a method of spraying the sheet-forming application liquid on the inner wall surface of the container, a method of freely dropping the sheet-forming application liquid on the inner wall surface of the container, a method of passing the container in the sheet-forming application liquid, a method of immersing the container in the sheet-forming application liquid, a method of supplying the sheet-forming application liquid to the rotating container, and the like.

From the viewpoint of more uniformly and efficiently applying the sheet-forming application liquid onto the inner wall surface of the container, it is preferable to apply the sheet-forming application liquid onto the inner wall surface of the container by moving the container.

The “moving the container” may be changing the orientation of the container, rotating the container, or shaking the container. Changing the orientation of the container, rotating the container, and shaking the container are preferable from the viewpoint of activating the metal catalyst, and rotating the container is more preferable. When rotating the container, it is preferable to rotate the container in a state in which the axis of the container is a rotation axis.

When the sheet-forming application liquid is uniformly applied onto the inner wall surface of the container, it becomes possible to form a polyolefin sheet having a uniform film thickness distribution.

The rotational rate of the container is not particularly limited, and may be set, as appropriate, in consideration of, for example, the viscosity (fluidity) of the sheet-forming application liquid, the target film thickness, and the production efficiency.

The rotational rate of the container may be, for example, from 1 rpm (revolution per minute; hereinafter, the same applies) to 1,000 rpm.

Generally, the metal catalyst and the co-catalyst are unstable in the air in many cases. Therefore, the application of the sheet-forming application liquid onto the inner wall surface of the container is preferably carried out in a nitrogen atmosphere from the viewpoint of the stability of the metal catalyst and the co-catalyst.

### Step B

Step B is a step of synthesizing a polyolefin on the inner wall surface of the container by introducing an olefin monomer into the container, in which the sheet-forming application liquid (that is, an organic solvent containing a metal catalyst) has been applied onto the inner wall surface.

According to the step B, a polyolefin film is formed on the inner wall surface of the container. The ratio of the formed polyolefin film to the entire area of the inner wall surface of the container is preferably 80% or more, more preferably 90% or more, and still more preferably 100%.

The olefin monomer is not particularly limited, and is, for example, ethylene, propylene, 1-butene, 1-pentene, 1-hexene, 1-octene, 1-nonene, 1-decene, 4-methyl-1-pentene, cyclopentene, 3-methylcyclopentene, 3-ethylcyclopentene, 4-methylcyclopentene, 4-ethylcyclopentene, norbornene or a derivative thereof, styrene or a derivative thereof, vinylcyclohexane, allylcyclohexane, 4-cyclohexyl-1-butene, 5-cyclohexyl-1-pentene, 6-cyclohexyl-1-hexene, or tert-butylethylene. Here, the “derivative” means a compound having an arbitrary substituent on 5-position and/or 6-position of norbornene, a benzene ring of styrene, or the like.

The olefin monomer is preferably at least one selected from the group consisting of ethylene, propylene, 1-butene, 1-pentene, 1-hexene, 1-octene, 1-nonene, 1-decene, 4-methyl-1-pentene, cyclopentene, norbornene, styrene, vinylcyclohexane, allylcyclohexane, 4-cyclohexyl-1-butene, 5-cyclohexyl-1-pentene, 6-cyclohexyl-1-hexene, and tert-butylethylene, and is particularly preferably ethylene.

The olefin monomer introduced into the container, in which the sheet-forming application liquid (that is, the organic solvent containing a metal catalyst) has been applied onto the inner wall surface, is preferably in a gas or liquid state, and more preferably in a gas state.

For example, when the olefin monomer is in a gas state (so-called gas), the pressure of the gas introduced into the container is not particularly limited, and is, for example, preferably from 0.1 MPa to 10 MPa, more preferably from 0.2 MPa to 5 MPa, and still more preferably from 0.5 MPa to 4 MPa.

The pressure of the gas is a value measured by a pressure gauge connected to the reaction container. As the pressure gauge, for example, a pressure gauge manufactured by Taiatsu Techno Corp. can be suitably used. However, the pressure gauge is not limited thereto.

The method of introducing an olefin monomer into the container may be, for example, a method of blowing the olefin monomer into the container, or may be a method of dropping the olefin monomer from the antigravity direction of the container into the container.

When the olefin monomer is introduced into the container, in which the sheet-forming application liquid has been applied onto the inner wall surface, the polymerization reaction of the olefin monomer occurs on the inner wall surface of the container, and the polyolefin is synthesized.

The polymerization time is not particularly limited, and may be, for example, from one minute to 120 minutes.

The polymerization time refers to from the point of time when the olefin monomer is introduced into the container to the point of time when the inner pressure of the container is released

The polymerization temperature is not particularly limited, and is, for example, preferably from 0° C. to 150° C., more preferably from 5° C. to 100° C., and still more preferably from 10° C. to 80° C.

In the step B, a polymerization terminator may be used to terminate the polymerization reaction of the olefin monomer.

The polymerization terminator is not particularly limited as long as the polymerization terminator has high reactivity to the activated terminal groups.

Examples of the polymerization terminator include additives such as methanol, ethanol, and 2-propanol.

The step B may be, for example, a step (hereinafter also referred to as a “step BX”) in which, as the olefin monomer, a monomer containing ethylene in an amount of 50 mass % or more with respect to a total mass of the monomer is introduced into the container, in which the sheet-forming application liquid (that is, the organic solvent containing a metal catalyst) has been applied onto the inner wall surface, thereby synthesizing, on the inner wall surface of the container, an ultra-high molecular weight polyethylene having a weight average molecular weight (Mw) of 500,000 or more.

When the step B is the step BX, in the step BX, the mass ratio of ethylene to the total mass of the monomer introduced into the container may be, for example, 60 mass % or more, 70 mass % or more, 80 mass % or more, 90 mass % or more, or 100 mass %.

When the step B is the step BX, the weight average molecular weight (Mw) of the ultra-high molecular weight polyethylene to be synthesized in the step BX is 500,000 or more, and may be, for example, 800,000 or more, 1,000,000 or more, or 1,200,000 or more. The weight average molecular weight (Mw) of the ultra-high molecular weight polyethylene to be synthesized may be, for example, 15,000,000 or less, or 6,000,000 or less.

In an embodiment, the weight average molecular weight (Mw) of the ultra-high molecular weight polyethylene to be synthesized may be 500,000 or more but 15,000,000 or less, 800,000 or more but 6,000,000 or less, 1,000,000 or more but 6,000,000 or less, or 1,200,000 or more but 6,000,000 or less.

The weight average molecular weight (Mw) of the ultra-high molecular weight polyethylene can be controlled by, for example, the polymerization time, the amount of olefin monomer (such as ethylene) to be introduced, the amount of catalyst, the amount of co-catalyst, the amount of solvent, and the like.

When the step B is the step BX, the molecular weight distribution index of the ultra-high molecular weight polyethylene to be synthesized in the step BX is not particularly limited, and may be, for example, from 1 to 20, from 1 to 10, from 1 to 7, or from 1 to 5.

The molecular weight distribution index is a value (Mw/Mn) obtained by dividing the weight average molecular weight (Mw) by the number average molecular weight (Mn).

In the synthesis of polyolefin (such as polyethylene), when a metallocene complex is selected as the metal catalyst, the molecular weight distribution of the obtained polyolefin (such as polyethylene) tends to be narrower. In general, as the molecular weight distribution of the polyolefin (such as polyethylene) is narrower, that is, as the value of the molecular weight distribution index (Mw/Mn) is smaller, the tear strength of the sheet is higher.

In the present disclosure, the weight average molecular weight (Mw) and the number average molecular weight (Mn) of the polyolefin (such as polyethylene) are values estimated from the molecular weight distribution curve of the contained polyethylene obtained by carrying out a gel permeation chromatography (GPC) measurement at 150° C. using 1,2,4-trichlorobenzene as an eluent.

The GPC measurement is specifically carried out under the following conditions.

### Conditions

Apparatus: HLC-8121GPC/HT (detector: RI) [manufactured by TOSOH CORPORATION]
Column: three of TSLgel GMHHR-H(20)HT [7.8 mm I.D.×30 cm, manufactured by TOSOH CORPORATION] are connected
Eluent: 1,2,4-trichlorobenzene [HPLC grade, manufactured by FUJIFILM Wako Pure Chemical Corporation] to which 0.05 mass % dibutylhydroxytoluene (BHT; antioxidant) has been added
Flow rate: 1.0 mL/min
Detection condition: polarity=(−)
Injection amount: 0.3 mL
Column temperature: 150° C.
Sample concentration: from 0.1 mg/mL to 1.0 mg/mL (solvent: 1,2,4-trichlorobenzene)

### Other Steps

The production method according to the present disclosure may include steps (so-called, other steps) other than the steps A and B described above.

Examples of other steps include a first cleaning step, a peeling step, a second cleaning step, and a drying step.

### First Cleaning Step

When the sheet-forming application liquid contains a co-catalyst, the production method according to the present disclosure preferably includes a first cleaning step.

The first cleaning step is a step of cleaning the synthesized polyolefin.

In the first cleaning step, the co-catalyst adhering to the polyolefin is removed.

Examples of the cleaning liquid include, but are not limited to, hydrochloric acid, methanol, ethanol, 2-propanol, and mixtures thereof.

The cleaning method is not particularly limited, and may be, for example, a method of cleaning a polyolefin by adding a cleaning liquid into the container and then rotating the container

### Peeling Step

The peeling step is a step of peeling the synthesized polyolefin from the inner wall surface of the container.

The polyolefin synthesized in the step B forms a film (so-called, polyolefin film) on the inner wall surface of the container. In the peeling step, the polyolefin can be peeled as a film.

The peeling method is not particularly limited, and a known peeling method can be applied.

### Second Cleaning Step

The second cleaning step is a step of cleaning the peeled polyolefin film.

In the second cleaning step, the metal catalyst adhering to the polyolefin film and the cleaning liquid used in the first cleaning step are removed.

Examples of the cleaning liquid include, but are not limited to, methanol, acetone, toluene, xylene, pentane, hexane, and mixtures thereof.

Examples of the cleaning method include, but are not limited to, a method of immersing in the cleaning liquid, a method of spraying the cleaning liquid, and the like.

### Drying Step

The drying step is a step of drying the cleaned polyolefin film.

In the drying step, the cleaning liquid adhering to the polyolefin film is removed.

The drying method is not particularly limited, and a known drying method can be applied.

Examples of the drying method include a method of drying by air (so-called, air drying) and a method of drying by heat.

### Film Thickness of Polyolefin Sheet

According to the production method according to the present disclosure, not only a thin polyolefin sheet but also a thick polyolefin sheet can be obtained. According to the production method according to the present disclosure, it is possible to obtain a polyolefin sheet having excellent film thickness uniformity.

The average film thickness of the polyolefin sheet obtained by the production method according to the present disclosure is, for example, from 1 μm to 1000 μm. According to the production method according to the present disclosure, the average film thickness of the polyolefin sheet can be, for example, 50 μm or more, 100 μm or more, or 200 μm or more.

In the present disclosure, the average film thickness of a polyolefin sheet (such as a polyethylene sheet) is an average film thickness obtained by the following measurement method.

The arithmetic average value of the film thickness values measured at six locations randomly selected in the thickness direction of the polyolefin sheet is obtained, and the obtained value is defined as the average film thickness of the polyolefin sheet. A thickness tester is used to measure the film thickness of the polyolefin sheet.

As the thickness tester, for example, a film tester (model number: HKT-1216) manufactured by Fujiwork Co., Ltd. can be suitably used. However, the thickness tester is not limited thereto.

### Area of Polyolefin Sheet

According to the production method according to the present disclosure, a polyolefin sheet having a large area can be obtained. In the production method according to the present disclosure, the area of the polyolefin sheet can be increased in accordance with the area of the inner wall surface of the container, to which the sheet-forming application liquid is applied.

The area of the polyolefin sheet obtained by the production method according to the present disclosure is, for example, from 1 cm² to 10000 cm². According to the production method according to the present disclosure, the area of the obtained polyolefin sheet can be, for example, 25 cm² or more, 100 cm² or more, 400 cm² or more, or 900 cm² or more.

### Shape of Polyolefin Sheet

The shape of the polyolefin sheet obtained by the production method according to the present disclosure is not particularly limited. According to the production method according to the present disclosure, various shapes of polyolefin sheets can be obtained according to the shape of the inner wall surface of the container, to which the sheet-forming application liquid is applied.

Examples of the shape of the polyolefin sheet obtained by the production method according to the present disclosure include shapes such as circular, semicircular, elliptical, rectangular, square, trapezoidal, and irregular shapes.

### Ultra-High Molecular Weight Polyethylene Sheet

The ultra-high molecular weight polyethylene sheet according to the present disclosure contains an ultra-high molecular weight polyethylene having a weight average molecular weight (Mw) of 500,000 or more in an amount of 50 mass % or more with respect to a total mass of the ultra-high molecular weight polyethylene sheet, wherein:
the ultra-high molecular weight polyethylene sheet has only one melting peak in a measurement by a differential scanning calorimeter;
a temperature of the melting peak (so-called, melting peak temperature (Tpm)) is 138° C. or more but less than 145° C.; and
a crystallinity calculated by dividing a melting heat obtained from an area of the melting peak by a melting heat of a polyethylene perfect crystal is 65% or more.

The ultra-high molecular weight polyethylene sheet according to the present disclosure is an ultra-high molecular weight polyethylene sheet having a high tear strength.

The ultra-high molecular weight polyethylene sheet according to the present disclosure contains an ultra-high molecular weight polyethylene having a weight average molecular weight (Mw) of 500,000 or more. The ultra-high molecular weight polyethylene having a weight average molecular weight (Mw) of 500,000 or more contained in the ultra-high molecular weight polyethylene sheet according to the present disclosure may be one type or may be two or more types.

The content of the ultra-high molecular weight polyethylene having a weight average molecular weight (Mw) of 500,000 or more in the ultra-high molecular weight polyethylene sheet according to the present disclosure is 50 mass % or more, preferably 60 mass % or more, more preferably 70 mass % or more, still more preferably 80 mass % or more, and particularly preferably 90 mass % or more, and may be 100 mass %, with respect to the total mass of the ultra-high molecular weight polyethylene sheet.

The fact that the content of the ultra-high molecular weight polyethylene having a weight average molecular weight (Mw) of 500,000 or more in the ultra-high molecular weight polyethylene sheet is 50 mass % or more with respect to the total mass of the ultra-high molecular weight polyethylene sheet means that the ultra-high molecular weight polyethylene having a weight average molecular weight (Mw) of 500,000 or more is the main component of the ultra-high molecular weight polyethylene sheet.

In the ultra-high molecular weight polyethylene sheet according to the present disclosure, the weight average molecular weight (Mw) of the ultra-high molecular weight polyethylene contained in an amount of 50 mass % or more is 500,000 or more, preferably 800,000 or more, more preferably 1,000,000 or more, and still more preferably 1,200,000 or more. In addition, in the ultra-high molecular weight polyethylene sheet according to the present disclosure, the weight average molecular weight (Mw) of the ultra-high molecular weight polyethylene contained in an amount of 50 mass % or more is preferably 15,000,000 or less, and more preferably 6,000,000 or less.

In an embodiment, in the ultra-high molecular weight polyethylene sheet according to the present disclosure, the weight average molecular weight (Mw) of the ultra-high molecular weight polyethylene contained in an amount of 50 mass % or more may be 500,000 or more but 15,000,000 or less, 800,000 or more but 6,000,000 or less, 1,000,000 or more but 6,000,000 or less, or 1,200,000 or more but 6,000,000 or less.

The weight average molecular weight (Mw) of the ultra-high molecular weight polyethylene is a value obtained by the GPC measurement described above similarly to the weight average molecular weight (Mw) of the polyolefin (such as polyethylene).

The ultra-high molecular weight polyethylene sheet according to the present disclosure may contain components (so-called, other components) other than the ultra-high molecular weight polyethylene having a weight average molecular weight (Mw) of 500,000 or more as needed within a range that does not impair the effects of the present disclosure.

Examples of other components include components to be added to normal polyolefin such as an antioxidant, a weather resistant agent, a light stabilizer, an ultraviolet absorber, a thermal stabilizer, an antistatic agent, a flame retardant, an antibacterial agent, an antifungal agent, and a colorant (for example, a pigment).

The ultra-high molecular weight polyethylene sheet according to the present disclosure has only one melting peak.

The fact that the ultra-high molecular weight polyethylene sheet according to the present disclosure has only one melting peak can be confirmed from a DSC curve obtained by a measurement by a differential scanning calorimeter (DSC).

The melting peak temperature (Tpm) of the ultra-high molecular weight polyethylene sheet according to the present disclosure is 138° C. or more but less than 145° C., preferably 138° C. or more but less than 143° C., more preferably 138° C. or more but less than 142° C., and still more preferably 138° C. or more but less than 141° C.

The crystallinity of the ultra-high molecular weight polyethylene sheet according to the present disclosure is 65% or more, preferably 70% or more, more preferably 75% or more, and still more preferably 80% or more.

The crystallinity of the polyethylene sheet is a value obtained by: dividing the melting heat (unit: J/g) obtained from the area of the melting peak in the DSC curve obtained by the measurement by the differential scanning calorimeter (DSC) by the melting heat (290 J/g) of the polyethylene perfect crystal; and conversion to percentage.

In general, an ultra-high molecular weight polyethylene sheet in which the ultra-high molecular weight polyethylene is in the state immediately after polymerization shows a melting point of 138° C. or more but less than 145° C. and has a crystallinity of 65% or more. That is, the fact that the melting peak temperature (Tpm) is 138° C. or more but less than 145° C. and the crystallinity is 65% or more means that the obtained ultra-high molecular weight polyethylene sheet is in the state immediately after polymerization, and is in a state of not having been melted or dissolved in a solvent after polymerization and film formation.

Further, in general, a stretched ultra-high molecular weight polyethylene sheet has two or more peaks (which may include a shoulder peak) since it includes both the melting point of the sheet before stretching and the melting point of extended chain crystals formed by stretching. That is, having only one melting peak means that the ultra-high molecular weight polyethylene sheet has not been stretched.

That is, the ultra-high molecular weight polyethylene sheet according to the present disclosure is characterized in that it has been formed only by polymerization, and it has not undergone a kneading step such as “melt kneading” or “kneading in a mixed state with a solvent”, a subsequent molding step such as “extrusion”, “compression molding”, “rolling”, “uniaxial stretching”, or “(simultaneous or sequential) biaxial stretching”, or the like.

The melting peak temperature (Tpm) of the polyethylene sheet is obtained from the DSC curve obtained by carrying out a measurement by a differential scanning calorimeter (DSC) that increases the temperature from 50° C. to 180° C. at a temperature increase rate of 10° C./min. The melting peak temperature (Tpm) is the temperature at the vertex of the melting peak.

The melting heat of the polyethylene sheet is obtained from the area of the melting peak in the DSC curve obtained by the measurement by the differential scanning calorimeter (DSC).

Details of the measurement method by the differential scanning calorimeter (DSC) are as follows.

A differential scanning calorimeter is used as a measurement apparatus, and about 2 mg of the ultra-high molecular weight polyethylene sheet is sealed in an aluminum pan and used for measurement. The temperature and heat quantity are calibrated with indium and tin as standard substances.

As the differential scanning calorimeter, for example, a differential scanning calorimeter (model number: DSC6200R) manufactured by Seiko Instruments Inc. can be suitably used. However, the differential scanning calorimeter is not limited thereto.

The molecular weight distribution index (Mw/Mn) of the ultra-high molecular weight polyethylene contained in the ultra-high molecular weight polyethylene sheet according to the present disclosure is not particularly limited, and is preferably 5 or less, more preferably 4 or less, and still more preferably 3 or less.

The lower limit of the molecular weight distribution index (Mw/Mn) of the ultra-high molecular weight polyethylene contained in the ultra-high molecular weight polyethylene sheet according to the present disclosure is not particularly limited, and is, for example, 1 or more.

As the molecular weight distribution of the ultra-high molecular weight polyethylene contained in the ultra-high molecular weight polyethylene sheet according to the present disclosure is narrower, that is, as the value of the molecular weight distribution index (Mw/Mn) is smaller, the tear strength of the ultra-high molecular weight polyethylene sheet according to the present disclosure tends to increase.

In an embodiment, the molecular weight distribution index (Mw/Mn) of the ultra-high molecular weight polyethylene contained in the ultra-high molecular weight polyethylene sheet according to the present disclosure may be 1 or more but 5 or less, may be 1 or more but 4 or less, or may be 1 or more but 3 or less.

The weight average molecular weight (Mw) and the number average molecular weight (Mn) of the ultra-high molecular weight polyethylene are values obtained by the GPC measurement described above, similarly to the weight average molecular weight (Mw) and the number average molecular weight (Mn) of the polyolefin (such as polyethylene).

The ultra-high molecular weight polyethylene sheet according to the present disclosure is characterized in that it has a low anisotropy in structure.

The degree of orientation of the ultra-high molecular weight polyethylene sheet according to the present disclosure is preferably 50% or less, more preferably 45% or less, and still more preferably 40% or less.

The degree of orientation of the ultra-high molecular weight polyethylene sheet according to the present disclosure is estimated from the orthorhombic (110) reflection intensity of a diffraction image (so-called, two-dimensional image) obtained by normal incident X-rays on the sheet surface. The degree of orientation is calculated according to the following formula from the peak full-width at half maximum (FWHM) of the azimuthal angle profile obtained by scanning the orthorhombic (110) reflection of the diffraction image in the azimuthal angle direction. For details, a document (Y. Ono, M. Kakiage, T. Yamanobe, Y. Yukawa, Y. Higuchi, H. Kamiya, K. Arai, H. Uehara, Polymer, 2011, Vol. 52, pp. 1172-1179) can be referred to. In this regard, when the azimuthal angle profile is flat and no peak is recognized, the degree of orientation is regarded as 0%.

$$Degree of orientation ( \% ) = \{ ( 180 ° - FWHM [ ° ] ) / 180 ° \} \times 100$$

In an embodiment, the degree of orientation of the ultra-high molecular weight polyethylene sheet according to the present disclosure may be 0% or more but 50% or less, may be 0% or more but 45% or less, or may be 0% or more but 40% or less.

As an X-ray measurement apparatus for obtaining a wide-angle X-ray diffraction image, for example, a combination of an X-ray generator (model number: MicroMaX007/HF) manufactured by Rigaku Holdings Corporation, an image intensifier (model number: V7739) manufactured by Hamamatsu Photonics K.K., and a CCD camera (model number: C4742-98) manufactured by Hamamatsu Photonics K.K. can be suitably used. However, the X-ray measurement apparatus is not limited to the combination.

The ultra-high molecular weight polyethylene sheet according to the present disclosure is characterized in that it has a high tear strength.

The tear strength of the ultra-high molecular weight polyethylene sheet according to the present disclosure is preferably 20 N/mm or more, more preferably 25 N/mm or more, and still more preferably 30 N/mm or more.

The upper limit of the tear strength of the ultra-high molecular weight polyethylene sheet according to the present disclosure is not particularly limited, and is, for example, 1000 N/mm or less.

In an embodiment, the tear strength of the ultra-high molecular weight polyethylene sheet according to the present disclosure may be 20 N/mm or more but 1000 N/mm or less, may be 25 N/mm or more but 1000 N/mm or less, or may be 30 N/mm or more but 1000 N/mm or less.

The tear strength of the polyethylene sheet is obtained by the following measurement method.

The polyethylene sheet is cut into a size of 40 mm (length)×25 mm (width) to obtain a test piece. An incision in the length direction of 20 mm is made in the central part in the width direction of the test piece, the remaining 20 mm of the test piece, in which no incision is made, is pulled up and down in the length direction at a rate of 200 mm/min under an environment at an ambient temperature of 25° C. using a TENSILON universal testing machine as a measurement apparatus, and the maximum stress when tearing the test piece is recorded. The value obtained by dividing the maximum stress by the average film thickness of the test piece is defined as the tear strength. In this regard, the average film thickness of the test piece in this method is calculated by assuming that the true density of the polyethylene in the polyethylene sheet is 1.000 g/cm³, and by dividing the mass of the test piece by the length of the test piece and the width of the test piece. Specifically, the average film thickness of the test piece in this method is obtained by the following calculation formula.

$$“ average film thickness ( mm ) of test piece ” = “ mass ( mg ) of test piece ” \text{} / ( “ length ( mm ) of test piece ” \times “ width ( mm ) of test piece ” )$$

As the TENSILON universal testing machine, for example, a TENSILON universal testing machine (model number: RTC-1325A) manufactured by ORIENTEC CORPORATION can be suitably used. However, the TENSILON universal testing machine is not limited thereto.

The ultra-high molecular weight polyethylene sheet according to the present disclosure is characterized in that it has a high tensile breaking strength.

The tensile breaking strength of the ultra-high molecular weight polyethylene sheet according to the present disclosure is preferably 1 MPa or more, more preferably 2 MPa or more, and still more preferably 5 MPa or more.

The upper limit of the tensile breaking strength of the ultra-high molecular weight polyethylene sheet according to the present disclosure is not particularly limited, and is, for example, 1000 MPa or less.

In an embodiment, the tensile breaking strength of the ultra-high molecular weight polyethylene sheet according to the present disclosure may be 1 MPa or more but 1000 MPa or less, may be 2 MPa or more but 1000 MPa or less, or may be 5 MPa or more but 1000 MPa or less.

The ultra-high molecular weight polyethylene sheet according to the present disclosure is characterized in that it has a low anisotropy in physical properties.

The ratio of the tensile breaking strengths in the directions perpendicular to each other of the ultra-high molecular weight polyethylene sheet according to the present disclosure is preferably from 0.5 to 1.5, more preferably from 0.7 to 1.3, and still more preferably from 0.8 to 1.2.

At this time, the directions perpendicular to each other may be any directions with respect to the longitudinal direction of the sheet. The “longitudinal” of the “sheet” means the longer side of the sheet. In this regard, in a stretched sheet, the tensile breaking strength when pulled in parallel to the stretching direction is considerably lower than that when pulled perpendicular to the stretching direction, and the ratio of the tensile breaking strengths in these directions perpendicular to each other does not satisfy from 0.8 to 1.2.

The tensile breaking strength of the polyethylene sheet is obtained by the following measurement method.

The polyethylene sheet is cut into a size of 30 mm (length; initial length)×5 mm (width) to obtain a test piece. The test piece is subjected to a tensile test at a stretching rate of 20 mm/min under an environment at an ambient temperature of 25° C. using a TENSILON universal testing machine as a measurement apparatus. The test piece is pulled in the length direction. The value obtained by dividing the maximum stress of the recorded stress chart by the cross-sectional area of the test piece is defined as the tensile breaking strength. The cross-sectional area of the test piece in this method is calculated by assuming that the true density of the polyethylene in the polyethylene sheet is 1.000 g/cm³, and by dividing the mass of the test piece by the length of the test piece. Specifically, the cross-sectional area of the test piece is obtained by the following calculation formula.

$$“ cross ‐ sectional area ( {mm}^{2} ) of test piece ” = “ mass ( mg ) of test piece ” / “ length ( mm ) of test piece ”$$

As the TENSILON universal testing machine, for example, a TENSILON universal testing machine (model number: RTC-1325A) manufactured by ORIENTEC CORPORATION can be suitably used. However, the TENSILON universal testing machine is not limited thereto.

The ratio of the tear strengths in the directions perpendicular to each other of the ultra-high molecular weight polyethylene sheet according to the present disclosure is preferably from 0.5 to 1.5, more preferably from 0.7 to 1.3, and still more preferably from 0.9 to 1.1.

At this time, the directions perpendicular to each other may be any directions with respect to the longitudinal direction of the sheet. In this regard, in a stretched sheet having different stretch ratios in the longitudinal direction and the width direction of the sheet, the tear strength when the incision is made parallel to the stretching direction is considerably lower than that when the incision is made perpendicular to the stretching direction, and the ratio of the tear strengths in these directions perpendicular to each other does not satisfy from 0.5 to 1.5.

The ultra-high molecular weight polyethylene sheet according to the present disclosure is characterized in that it has a high water repellency.

The water contact angle at 25° C. of the ultra-high molecular weight polyethylene sheet according to the present disclosure is preferably 100° or more, more preferably 110° or more, and still more preferably 120° or more.

The upper limit value of the contact angle is 180° in principle.

The contact angle is an angle θ formed by the tangent of the droplet and the solid surface when the liquid is dropped onto the solid surface. As a method of measuring the contact angle, a θ/2 method is used in general, and this method is also used in the present disclosure. Specifically, the contact angle of the polyethylene sheet is obtained by the following measurement method.

The polyethylene sheet is cut into a circular shape having a diameter of 1 cm to obtain a test piece. The test piece is fixed to the stage of the contact angle meter. A water droplet is formed at the tip of the needle of the syringe mounted on the contact angle meter, and the height of the stage is adjusted to bring the test piece close to the formed water droplet. When the water droplet comes into contact with the test piece, the stage is lowered to attach the droplet onto the test piece. In this state, the droplet and the test piece are observed from the side through a magnifying lens, whereby the contact angle is measured.

The measurement is carried out under an environment at an ambient temperature of 25° C.

As the contact angle meter, for example, a contact angle meter (model number: DropMaster100) manufactured by Kyowa Interface Science Co., Ltd. can be suitably used. However, the contact angle meter is not limited thereto.

The ultra-high molecular weight polyethylene sheet according to the present disclosure has a surface structure having worm-like (also referred to as “earthworm-like”, hereinafter, the same applies) and/or spherical protrusions, and it is presumed that the sheet surface shows water repellency due to such a surface structure.

From the viewpoint of indicating the above contact angle, the width of each of the worm-like and spherical protrusions present on the surface of the ultra-high molecular weight polyethylene sheet according to the present disclosure is preferably from 1 μm to 500 μm, more preferably from 10 μm to 500 μm, and still more preferably from 50 μm to 500 μm. The “width” when the protrusion is spherical means a diameter.

From the viewpoint of indicating the above contact angle, the length of the worm-like protrusion present on the surface of the ultra-high molecular weight polyethylene sheet according to the present disclosure is preferably from 1 μm to 5000 μm, more preferably from 10 μm to 1000 μm, and still more preferably from 10 μm to 500 μm. When the worm-like protrusion is bent, the length of the trajectory of the center point of the width is regarded as the length of the worm-like protrusion.

Further, from the viewpoint of indicating the above contact angle, the total area of the worm-like and spherical protrusions present on the surface of the ultra-high molecular weight polyethylene sheet according to the present disclosure is preferably from 5% to 100%, more preferably from 10% to 100%, and still more preferably from 15% to 100%, with respect to the surface area of the ultra-high molecular weight polyethylene sheet according to the present disclosure.

The surface structure having these characteristic protrusions can be confirmed by a scanning electron microscope (SEM) image.

The ultra-high molecular weight polyethylene sheet according to the present disclosure is characterized in that it has a small dimensional change during heating.

In the ultra-high molecular weight polyethylene sheet according to the present disclosure, an absolute value of a dimensional change rate in a parallel direction with respect to a sheet surface is preferably less than 20%, more preferably 15% or less, and still more preferably 10% or less, when heated at 140° C. for 10 minutes.

The lower limit of the absolute value of the dimensional change rate is not particularly limited, but in principle, 0% is the minimum value. The dimensional change rate in the parallel direction with respect to the sheet surface when the polyethylene sheet is heated at 140° C. for 10 minutes is obtained by the following measurement method.

A polyethylene sheet having 3-cm square ink marks added in advance is charged into an oil bath held at 140° C., and taken out after a lapse of 10 minutes, and a distance between the ink marks is measured. The dimensional change rate (%) is calculated by dividing the displacement from the original length 3 cm by the original length 3 cm.

Here, in the case in which the displacement from the original length 3 cm by heating is a positive value, it means that the polyethylene sheet expands with respect to the measurement direction of the displacement, and in the case in which the displacement is a negative value, it means that the sheet shrinks with respect to the measurement direction of the displacement. Therefore, in the former case, it is desirable that the dimensional change rate, which is a positive value, is smaller, and in the latter case, it is desirable that the dimensional change rate, which is a negative value, is larger. That is, it is desirable that the dimensional change rate is closer to 0. In order to numerically define this, in the present disclosure, the absolute value of the dimensional change rate is used.

The average film thickness of the ultra-high molecular weight polyethylene sheet according to the present disclosure is not particularly limited, and is, for example, preferably 100 μm or more, more preferably 150 μm or more, and still more preferably 200 μm or more.

The upper limit of the average film thickness of the ultra-high molecular weight polyethylene sheet according to the present disclosure is, for example, preferably 1000 μm or less.

In an embodiment, the average film thickness of the ultra-high molecular weight polyethylene sheet according to the present disclosure may be 100 μm or more but 1000 μm or less, may be 150 μm or more but 1000 μm or less, or may be 200 μm or more but 1000 μm or less.

The method for measuring the film thickness of the polyethylene sheet and the method for obtaining the average film thickness are as described above. The ultra-high molecular weight polyethylene sheet according to the present disclosure can be more suitably produced by the method for producing a polyolefin according to the present disclosure as described above.

The ultra-high molecular weight polyethylene sheet according to the present disclosure can be produced by, for example, selecting ethylene as the olefin monomer and adjusting the weight average molecular weight by controlling the polymerization conditions (for example, the polymerization time, the amount of ethylene to be introduced, the amount of the catalyst, the amount of the co-catalyst, and the amount of the solvent) in the method for producing a polyolefin according to the present disclosure.

### EXAMPLES

In the following Examples listed, the method for producing a polyolefin sheet and the ultra-high molecular weight polyethylene sheet according to the present disclosure are further specifically described. The material, the used amount, the ratio, the processing procedure, and the like shown in the following Examples can be changed as appropriate without departing from the spirit of the present disclosure. Therefore, the scope of the method for producing a polyolefin sheet and the ultra-high molecular weight polyethylene sheet according to the present disclosure should not be construed as being limited by the specific examples shown below.

First, Examples of the method for producing a polyolefin sheet according to the present disclosure are described.

### Production of Polyolefin Sheet

### Production Example 1

Into a 96 mL volume pressure-resistant container made of glass [model number: HPG-96-3, shape: round tube shape, area of inner wall surface: about 150 cm², manufactured by Taiatsu Techno Corp.], 0.00014 g (0.00058 mmol) of bis(cyclopentadienyl)titanium (IV) dichloride [metal catalyst] and 0.28 mL of toluene [organic solvent] were added under nitrogen atmosphere, and then 0.42 mL (Al: 1.2 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 2 MPa) was blown and introduced into the pressure-resistant container, and the ethylene was polymerized while rotating the pressure-resistant container on the rotator for 60 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 1.52 g of a polyethylene sheet 1 (also referred to as a “sheet 1”), which was one type of polyolefin sheet, was obtained. The obtained sheet 1 was a rectangular sheet having a size of 15 cm×8 cm, and had an area of 120 cm².

### Production Example 2

Into a 96 mL volume pressure-resistant container made of glass [model number: HPG-96-3, shape: round tube shape, area of inner wall surface: about 150 cm², manufactured by Taiatsu Techno Corp.], 0.00014 g (0.00058 mmol) of bis(cyclopentadienyl)titanium (IV) dichloride [metal catalyst] and 0.28 mL of toluene [organic solvent] were added under nitrogen atmosphere, and then 0.42 mL (Al: 1.2 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 1 MPa) was blown and introduced into the pressure-resistant container, and the ethylene was polymerized while rotating the pressure-resistant container on the rotator for 180 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 1.21 g of a polyethylene sheet 2 (also referred to as a “sheet 2”), which was one type of polyolefin sheet, was obtained. The obtained sheet 2 was a rectangular sheet having a size of 15 cm×8 cm, and had an area of 120 cm².

### Production Example 3

Into a 96 mL volume pressure-resistant container made of glass [model number: HPG-96-3, shape: round tube shape, area of inner wall surface: about 150 cm², manufactured by Taiatsu Techno Corp.], 0.0020 g (0.0050 mmol) of bis(cyclopentadienyl)hafnium (IV) dichloride [metal catalyst] and 2.1 mL of toluene [organic solvent] were added under nitrogen atmosphere, and then 0.88 mL (Al: 2.5 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 1 MPa) was blown and introduced into the pressure-resistant container, and the ethylene was polymerized while rotating the pressure-resistant container on the rotator for 120 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 1.23 g of a polyethylene sheet 3 (also referred to as a “sheet 3”), which was one type of polyolefin sheet, was obtained. The obtained sheet 3 was a rectangular sheet having a size of 15 cm×8 cm, and had an area of 120 cm².

### Production Example 4

Into a 96 mL volume pressure-resistant container made of glass [model number: HPG-96-3, shape: round tube shape, area of inner wall surface: about 150 cm², manufactured by Taiatsu Techno Corp.], 0.00053 g (0.00125 mmol) of (S,S)-ethylenebis(4,5,6,7-tetrahydroindenyl)zirconium (IV) dichloride [metal catalyst] and 0.60 mL of toluene [organic solvent] were added under nitrogen atmosphere, and then 0.88 mL (Al: 2.5 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 2 MPa) was blown and introduced into the pressure-resistant container, and the ethylene was polymerized while rotating the pressure-resistant container on the rotator for 120 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 2.60 g of a polyethylene sheet 4 (also referred to as a “sheet 4”), which was one type of polyolefin sheet, was obtained. The obtained sheet 4 was a rectangular sheet having a size of 15 cm×8 cm, and had an area of 120 cm².

### Production Example 5

Into a 96 mL volume pressure-resistant container made of glass [model number: HPG-96-3, shape: round tube shape, area of inner wall surface: about 150 cm², manufactured by Taiatsu Techno Corp.], 0.0013 g (0.0050 mmol) of bis(cyclopentadienyl)titanium (IV) dichloride [metal catalyst] and 2.1 mL of toluene [organic solvent] were added under nitrogen atmosphere, and then 0.88 mL (Al: 2.5 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 1 MPa) was blown and introduced into the pressure-resistant container, and the ethylene was polymerized while rotating the pressure-resistant container on the rotator for 120 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 1.08 g of a polyethylene sheet 5 (also referred to as a “sheet 5”), which was one type of polyolefin sheet, was obtained. The obtained sheet 5 was a rectangular sheet having a size of 15 cm×8 cm, and had an area of 120 cm².

### Production Example 6

Into a 96 mL volume pressure-resistant container made of glass [model number: HPG-96-3, shape: round tube shape, area of inner wall surface: about 150 cm², manufactured by Taiatsu Techno Corp.], 0.00062 g (0.0025 mmol) of bis(cyclopentadienyl)titanium (IV) dichloride [metal catalyst] and 1.06 mL of toluene [organic solvent] were added under nitrogen atmosphere, and then 0.44 mL (Al: 1.25 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 2 MPa) was blown and introduced into the pressure-resistant container, and the ethylene was polymerized while rotating the pressure-resistant container on the rotator for 5 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 0.78 g of a polyethylene sheet 6 (also referred to as a “sheet 6”), which was one type of polyolefin sheet, was obtained. The obtained sheet 6 was a rectangular sheet having a size of 15 cm×8 cm, and had an area of 120 cm².

### Production Example 7

Into a 96 mL volume pressure-resistant container made of glass [model number: HPG-96-3, shape: round tube shape, area of inner wall surface: about 150 cm², manufactured by Taiatsu Techno Corp.], 0.00116 g (0.0025 mmol) of bis(propylcyclopentadienyl)hafnium (IV) dichloride [metal catalyst], 0.50 mL of hexane [organic solvent], and 0.10 mL of toluene [organic solvent] were added under nitrogen atmosphere, and then 0.88 mL (Al: 2.5 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 2 MPa) was blown and introduced into the pressure-resistant container, and the ethylene was polymerized while rotating the pressure-resistant container on the rotator for 120 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 2.4 g of a polyethylene sheet 7 (also referred to as a “sheet 7”), which was one type of polyolefin sheet, was obtained. The obtained sheet 7 was a rectangular sheet having a size of 15 cm×8 cm, and had an area of 120 cm².

### Production Example 8

Into a 96 mL volume pressure-resistant container made of glass [model number: HPG-96-3, shape: round tube shape, area of inner wall surface: about 150 cm², manufactured by Taiatsu Techno Corp.], 0.00062 g (0.0025 mmol) of bis(cyclopentadienyl)titanium (IV) dichloride [metal catalyst] and 0.90 mL of toluene [organic solvent] were added under nitrogen atmosphere, and then 0.60 mL (Al: 1.25 mmol) of a toluene solution of methylaluminoxane [co-catalyst] [product name: MMAO-3A, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 1 MPa) was blown and introduced into the pressure-resistant container, and the ethylene was polymerized while rotating the pressure-resistant container on the rotator for 5 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 0.39 g of a polyethylene sheet 8 (also referred to as a “sheet 8”), which was one type of polyolefin sheet, was obtained. The obtained sheet 8 was a rectangular sheet having a size of 15 cm×8 cm, and had an area of 120 cm².

### Production Example 9

Into a 96 mL volume pressure-resistant container made of glass [model number: HPG-96-3, shape: round tube shape, area of inner wall surface: about 150 cm², manufactured by Taiatsu Techno Corp.], 0.0012 g (0.0050 mmol) of bis(cyclopentadienyl)titanium (IV) dichloride [metal catalyst] and 0.56 mL of toluene [organic solvent] were added under nitrogen atmosphere, and then 0.38 mL (Al: 2.5 mmol) of a toluene solution of triisobutylaluminum [co-catalyst] [product name: TIBA, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C., and then adding 0.0046 g (0.0050 mmol) of triphenylmethylium tetrakis(pentafluorophenyl)borate [co-catalyst] and 0.56 mL of toluene [organic solvent], and again placing the pressure-resistant container sideways on a rotator and rotating it at a number of revolutions of 120 rpm for 10 minutes under an environment at an ambient temperature of 25° C. [step A].

Next, ethylene gas (pressure: 1 MPa) was blown and introduced into the pressure-resistant container, and the ethylene was polymerized while rotating the pressure-resistant container on the rotator for 120 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 1.47 g of a polyethylene sheet 9 (also referred to as a “sheet 9”), which was one type of polyolefin sheet, was obtained. The obtained sheet 9 was a rectangular sheet having a size of 15 cm×8 cm, and had an area of 120 cm².

### Production Example 10

Into a 96 mL volume pressure-resistant container made of glass [model number: HPG-96-3, shape: round tube shape, area of inner wall surface: about 150 cm², manufactured by Taiatsu Techno Corp.], 0.00062 g (0.0025 mmol) of bis(cyclopentadienyl)titanium (IV) dichloride [metal catalyst] and 1.05 mL of toluene [organic solvent] were added under nitrogen atmosphere, and then 0.45 mL (Al: 1.25 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A]

Next, ethylene gas (pressure: 0.1 MPa) was blown and introduced into the pressure-resistant container, and the ethylene was polymerized while rotating the pressure-resistant container on the rotator for 180 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 1.11 g of a polyethylene sheet 10 (also referred to as a “sheet 10”), which was one type of polyolefin sheet, was obtained. The obtained sheet 10 was a rectangular sheet having a size of 15 cm×8 cm, and had an area of 120 cm².

### Production Example 11

Into a 96 mL volume pressure-resistant container made of glass [model number: HPG-96-3, shape: round tube shape, area of inner wall surface: about 150 cm², manufactured by Taiatsu Techno Corp.], 0.00024 g (0.00058 mmol) of rac-ethylenebis(indenyl)zirconium (IV) dichloride [metal catalyst] and 0.28 mL of toluene [organic solvent] were added under nitrogen atmosphere, and then 0.42 mL (Al: 1.2 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container sideways on a rotator and rotating it at a number of revolutions of 120 rpm for 10 minutes under an environment at an ambient temperature of 25° C. [step A].

Next, ethylene gas (pressure: 1 MPa) was blown and introduced into the pressure-resistant container, and the ethylene was polymerized while rotating the pressure-resistant container on the rotator for 180 minutes, so that a polyethylene was synthesized on the inner wall surface of the pressure-resistant container [step B].

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 1.66 g of a polyethylene sheet 11 (also referred to as a “sheet 11”), which was one type of polyolefin sheet, was obtained. The obtained sheet 11 was a rectangular sheet having a size of 15 cm×8 cm, and had an area of 120 cm².

### Production Example 12

Into a 96 mL volume pressure-resistant container made of glass [model number: HPG-96-3, shape: round tube shape, area of inner wall surface: about 150 cm², manufactured by Taiatsu Techno Corp.], 0.00014 g (0.00058 mmol) of bis(cyclopentadienyl)titanium (IV) dichloride [metal catalyst] and 0.28 mL of toluene [organic solvent] were added to the bottom of the container, so as not to be in contact with the inner wall of the container, under nitrogen atmosphere, and then 0.42 mL (Al: 1.2 mmol) of a toluene solution of methylaluminoxane [co-catalyst] [product name: TMAO-212, manufactured by Tosoh Finechem Corporation] was added.

Next, ethylene gas (pressure: 2 MPa) was blown and introduced into the pressure-resistant container, and the ethylene was polymerized while letting the pressure-resistant container stand for 60 minutes, so that a polyethylene was synthesized on the bottom of the pressure-resistant container.

After the polymerization reaction was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was taken out from the bottom of the pressure-resistant container to obtain an aggregated polyethylene [peeling step].

Next, the taken out aggregated polyethylene was cleaned using methanol [cleaning liquid] and acetone [cleaning liquid] to remove the metal catalyst adhering to the aggregated polyethylene and the cleaning liquid used in the first cleaning step [second cleaning step].

Next, the cleaned aggregated polyethylene was air-dried [drying step].

Thus, 0.59 g of an aggregated polyethylene was obtained.

### Production Example 16

To the bottom in a 550 mL volume chain clamp type pressure-resistant container made of stainless steel [shape: round tube shape, bottom diameter: 93.6 mm, bottom area: about 63.6 cm², manufactured by Taiatsu Techno Corp.], 0.00062 g (0.0025 mmol) of bis(cyclopentadienyl)titanium (IV) dichloride [metal catalyst] and 0.62 mL of toluene [organic solvent] were added under nitrogen atmosphere, and then 0.88 mL (Al: 2.5 mmol) of a toluene solution of methylaluminoxane [co-catalyst] [product name: TMAO-212, manufactured by Tosoh Finechem Corporation] was added. Next, the liquid [an organic solvent containing a metal catalyst and a co-catalyst; so-called, sheet-forming application liquid] in the pressure-resistant container was applied onto the inner wall surface of the pressure-resistant container by placing the pressure-resistant container vertically on a shaker and shaking it at a number of revolutions of 80 rpm for 10 minutes under an environment at an ambient temperature of 25° C. [step A].

Next, ethylene gas (pressure: 1 MPa) was blown and introduced into the pressure-resistant container, and the ethylene was polymerized while shaking the pressure-resistant container on the shaker for 120 minutes, so that a polyethylene was synthesized on the inner wall surface of the pressure-resistant container [step B].

After the polymerization was completed, ethylene gas was removed, and ethanol [polymerization terminator] was added to terminate the reaction, and then a mixed liquid of hydrochloric acid and methanol (volume ratio 1:4) [cleaning liquid] was added into the pressure-resistant container to remove the co-catalyst adhering to the polyethylene [first cleaning step].

Next, the synthesized polyethylene was peeled from the inner wall surface of the pressure-resistant container to obtain a polyethylene film [peeling step].

Next, the peeled polyethylene film was cleaned using methanol [cleaning liquid] and acetone [cleaning liquid] to remove the metal catalyst adhering to the polyethylene film and the cleaning liquid used in the first cleaning step [second cleaning step].

Next, the cleaned polyethylene film was air-dried [drying step].

Thus, 1.3 g of a polyethylene sheet 16 (also referred to as a “sheet 16”), which was one type of polyolefin sheet, was obtained. The obtained sheet 16 was a circular sheet having a size of a diameter of 9 cm, and had an area of about 64 cm².

The film thickness of the obtained sheet 16 was measured by the method described in “1. Film thickness” of [Evaluation (1)] described below. As a result, the sheet 16 had a minimum value of film thickness of 0.478 mm, a maximum value of film thickness of 1.097 mm, an average film thickness of 0.699 mm, and a standard deviation of 0.203.

The melting peak temperature (Tpm) of the obtained sheet 16 was measured by the method described in “2. DSC measurement” of [Evaluation (1)] described below. As a result, the melting peak temperature (Tpm) of the sheet 16 was 139.1° C.

The weight average molecular weight (Mw) of the polyethylene contained in the obtained sheet 16 was measured by the method described in “3. Molecular weight measurement” of [Evaluation (1)] described below. As a result, the weight average molecular weight (Mw) of the polyethylene contained in the sheet 16 was 9.8×10⁶.

The viscosity at 20° C. of the sheet-forming application liquid in each of Production Examples 1 to 12 and 16 was measured using a vibration type viscometer (model number: VM-10A) manufactured by SEKONIC CORPORATION. The results are shown in Table 1.

The details of the metal catalyst, the co-catalyst, and the organic solvent in the sheet-forming application liquid in each of Production Examples 1 to 12 and 16 are shown in Table 1.

The polymerization conditions in each of Production Examples 1 to 12 and 16 are shown in Table 1.

TABLE 1

| | Metal catalyst | | Co-catalyst | |
|---|---|---|---|---|
| | | Concentration | | Concentration |
| | Type | [mol/L] | Type | [mol/L] |
| Production | bis(cyclopentadienyl)titanium (IV) | 0.00083 | TMAO | 1.7 |
| Example 1 | dichloride | | | |
| Production | bis(cyclopentadienyl)titanium (IV) | 0.00083 | TMAO | 1.7 |
| Example 2 | dichloride | | | |
| Production | bis(cyclopentadienyl)hafnium (IV) | 0.0017 | TMAO | 0.83 |
| Example 3 | dichloride | | | |
| Production | (S,S)-ethylenebis(4,5,6,7- | 0.00083 | TMAO | 1.7 |
| Example 4 | tetrahydroindenyl)zirconium (IV) | | | |
| | dichloride | | | |
| Production | bis(cyclopentadienyl)titanium (IV) | 0.0017 | TMAO | 0.83 |
| Example 5 | dichloride | | | |
| Production | bis(cyclopentadienyl)titanium (IV) | 0.0017 | TMAO | 0.83 |
| Example 6 | dichloride | | | |
| Production | bis(propylcyclopentadienyl)hafnium | 0.0017 | TMAO | 1.7 |
| Example 7 | (IV) dichloride | | | |
| Production | bis(cyclopentadienyl)titanium (IV) | 0.0017 | TMAO | 0.83 |
| Example 8 | dichloride | | | |
| Production | bis(cyclopentadienyl)titanium (IV) | 0.0033 | triisobutylaluminum/ | 1.7 |
| Example 9 | dichloride | | triphenylmethylium | |
| | | | tetrakis(pentafluorophenyl)borate | |
| Production | bis(cyclopentadienyl)titanium (IV) | 0.0017 | TMAO | 0.83 |
| Example 10 | dichloride | | | |
| Production | rac-ethylenebis(indenyl)zirconium | 0.00083 | TMAO | 1.7 |
| Example 11 | (IV) dichloride | | | |
| Production | bis(cyclopentadienyl)titanium (IV) | 0.00083 | TMAO | 1.7 |
| Example 12 | dichloride | | | |
| Production | bis(cyclopentadienyl)titanium (IV) | 0.0017 | TMAO | 1.7 |
| Example 16 | dichloride | | | |

| | | | Viscosity | | |
|---|---|---|---|---|---|
| | | | of sheet- | | |
| | | | forming | Polymerization | |
| | Organic solvent | | application | conditions | |
| | | Amount | liquid | Pressure | Polymerization |
| | Type | [mL] | [mPa · s] | [MPa] | time [min] |
| Production | toluene | 0.7 | 1.0 | 2 | 60 |
| Example 1 | | | | | |
| Production | toluene | 0.7 | 1.0 | 1 | 180 |
| Example 2 | | | | | |
| Production | toluene | 3.0 | 0.7 | 1 | 120 |
| Example 3 | | | | | |
| Production | toluene | 1.5 | 0.9 | 2 | 120 |
| Example 4 | | | | | |
| Production | toluene | 3.0 | 0.7 | 1 | 120 |
| Example 5 | | | | | |
| Production | toluene | 1.5 | 0.8 | 2 | 5 |
| Example 6 | | | | | |
| Production | hexane/ | 1.5 | 0.9 | 2 | 120 |
| Example 7 | toluene | | | | |
| Production | toluene | 1.5 | 0.8 | 1 | 5 |
| Example 8 | | | | | |
| Production | toluene | 1.5 | 0.9 | 1 | 120 |
| Example 9 | | | | | |
| Production | toluene | 1.5 | 0.8 | 0.1 | 180 |
| Example 10 | | | | | |
| Production | toluene | 0.7 | 1.0 | 1 | 180 |
| Example 11 | | | | | |
| Production | toluene | 0.7 | 1.0 | 2 | 60 |
| Example 12 | | | | | |
| Production | toluene | 1.5 | 0.9 | 1 | 120 |
| Example 16 | | | | | |

Among the production methods described in Production Examples 1 to 12 and 16, the production methods described in Production Examples 1 to 11 and 16 correspond to the method for producing a polyolefin sheet according to the present disclosure.

It was confirmed that according to the production method described in Production Examples 1 to 11 and 16, a polyolefin sheet that is a good self-supporting film is obtained.

In contrast, it was confirmed that according to the production method described in Production Example 12, which is carried out under the same polymerization conditions (the type and concentration of the metal catalyst, the type and concentration of the co-catalyst, the type and amount of the organic solvent, the pressure of the ethylene gas, and the polymerization time) as Production Example 1, but which does not include a step of applying an organic solvent containing a metal catalyst onto the inner wall surface of the container, a sheet-like polyolefin (that is, a polyolefin sheet) is not obtained.

### Evaluation (1)

The following evaluations were carried out for the polyolefin sheets (that is, sheets 1 to 11) obtained by the production methods described in Production Examples 1 to 11. For the aggregated polyethylene obtained by the production method described in Production Example 12, the evaluations other than the film thickness were carried out among the following evaluations.

### 1. Film Thickness

The film thickness was evaluated for each polyolefin sheet of the sheets 1 to 11 obtained above.

The film thicknesses at six locations randomly selected in the thickness direction of the sheet were measured using a thickness tester [product name: Film Tester, model number: HKT-1216, manufactured by Fujiwork Co., Ltd.]. An arithmetic average value was obtained from the measured values, and the obtained value was defined as the average film thickness of the sheet. The standard deviation was calculated from the measured film thicknesses at six locations, and the uniformity of the film thickness was evaluated on the basis of the obtained value. The evaluation criteria are as follows.

The minimum value and the maximum value, the average film thickness, and the standard deviation of the measured film thicknesses at six locations, and the evaluation result are shown in Table 2. When the evaluation result was “AA”, “A” or “B”, it was determined that there was no practical problem. The evaluation result is most preferably “AA”.

### Evaluation Criteria

AA: Standard deviation is 0 or more but less than 0.05.
A: Standard deviation is 0.05 or more but less than 0.1.
B: Standard deviation is 0.1 or more but less than 0.3.
C: Standard deviation is 0.3 or more.

### 2. DSC Measurement

For each of the polyolefin sheets of the sheets 1 to 11 and the aggregated polyethylene obtained above, DSC measurement was carried out, and the melting peak temperature (Tpm), the melting heat, and the crystallinity were obtained.

The melting peak temperature (Tpm) was obtained from a differential scanning calorimetry curve (DSC curve) obtained by carrying out differential scanning calorimetry (DSC). As the measurement apparatus, a differential scanning calorimeter (model number: DSC6200R) manufactured by Seiko Instruments Inc. was used, and about 2 mg of polyethylene sheet or aggregated polyethylene was used as a sample. The temperature at the vertex of the melting peak obtained when the sample was heated from 50° C. to 180° C. at a temperature increase rate of 10° C./min was defined as the melting peak temperature (Tpm). In addition, the value obtained by dividing the melting heat (unit: J/g) obtained from the area of the melting peak by the melting heat (290 J/g) of the polyethylene perfect crystal and conversion to percentage was defined as the crystallinity (unit: %). The temperature and heat quantity were calibrated with indium and tin as standard substances.

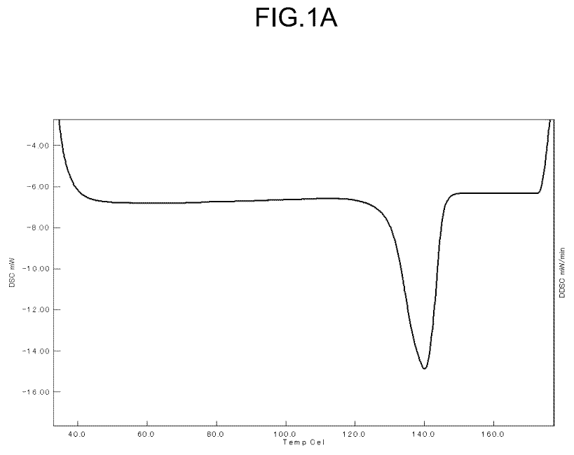

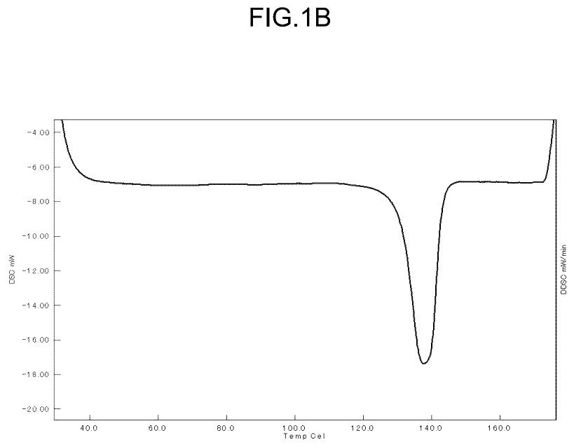

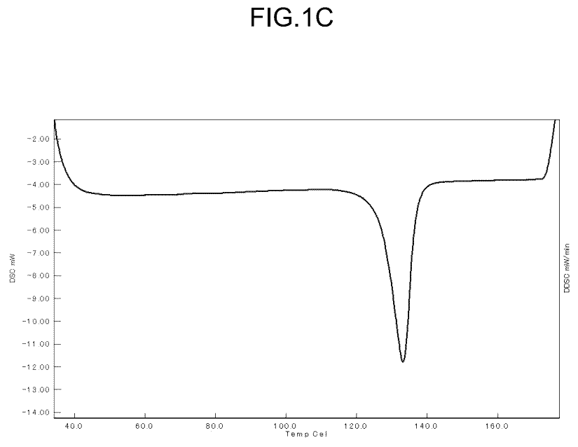

The melting peak temperature (indicated as “Tpm” in the table), the melting heat obtained from the area of the melting peak, and the crystallinity are shown in Table 2. The DSC curves of the sheets 1, 2, and 11 are shown in FIGS. 1A, 1B, and 1C, respectively.

### 3. Molecular Weight Measurement

The weight average molecular weight (Mw) and the number average molecular weight (Mn) of the polyethylene contained in each of the polyolefin sheets of the sheets 1 to 11 and the aggregated polyethylene obtained above were measured. The molecular weight distribution index (Mw/Mn) was obtained from the measured weight average molecular weight (Mw) and number average molecular weight (Mn).

The weight average molecular weight (Mw) and the number average molecular weight (Mn) of the polyethylene were estimated from the molecular weight distribution curve of the contained polyethylene obtained by carrying out a gel permeation chromatography (GPC) measurement at 150° C. using 1,2,4-trichlorobenzene as an eluent. The GPC measurement is specifically carried out under the following conditions.

The weight average molecular weight (Mw), the number average molecular weight (Mn), and the molecular weight distribution index (Mw/Mn) are shown in Table 2.

### Conditions

Apparatus: HLC-8121GPC/HT (detector: RI) [manufactured by TOSOH CORPORATION]
Column: three of TSLgel GMHHR-H(20)HT [7.8 mm I.D.×30 cm, manufactured by TOSOH CORPORATION] are connected
Eluent: 1,2,4-trichlorobenzene [HPLC grade, manufactured by FUJIFILM Wako Pure Chemical Corporation] to which 0.05 mass % dibutylhydroxytoluene (BHT; antioxidant) has been added
Flow rate: 1.0 mL/min
Detection condition: polarity=(−)
Injection amount: 0.3 mL
Column temperature: 150° C.
Sample concentration: 0.1 mg/mL (solvent: 1,2,4-trichlorobenzene)

TABLE 2

| | | Film thickness | | | | | | | | | | |
|---|---|---|---|---|---|---|---|---|---|---|---|---|
| | | | | | | Average | DSC measurement | | | | | |
| | | Uniformity | | Minimum | Maximum | film | | Melting | | Molecular weight measurement | | |
| | | Standard | Evaluation | value | value | thickness | Tpm | heat | Crystallinity | Mw | Mn | |
| | | deviation | result | [mm] | [mm] | [mm] | [° C.] | [J/g] | [%] | [×10⁶] | [×10⁶] | Mw/Mn |
| Production | Sheet 1 | 0.049 | AA | 0.245 | 0.385 | 0.317 | 140.1 | 258 | 89 | 3.1 | 1.0 | 3.0 |
| Example 1 | | | | | | | | | | | | |
| Production | Sheet 2 | 0.026 | AA | 0.277 | 0.341 | 0.307 | 138.0 | 231 | 80 | 1.5 | 0.51 | 2.9 |
| Example 2 | | | | | | | | | | | | |
| Production | Sheet 3 | 0.206 | B | 0.074 | 0.799 | 0.289 | 138.7 | 195 | 67 | 1.7 | 0.57 | 3.0 |
| Example 3 | | | | | | | | | | | | |
| Production | Sheet 4 | 0.073 | A | 0.729 | 0.972 | 0.841 | 139.3 | 249 | 86 | 2.2 | 0.74 | 3.0 |
| Example 4 | | | | | | | | | | | | |
| Production | Sheet 5 | 0.094 | A | 0.213 | 0.507 | 0.347 | 140.4 | 200 | 69 | 3.6 | 1.1 | 3.2 |
| Example 5 | | | | | | | | | | | | |
| Production | Sheet 6 | 0.111 | B | 0.278 | 0.616 | 0.398 | 140.3 | 224 | 77 | 3.5 | 1.1 | 3.1 |
| Example 6 | | | | | | | | | | | | |
| Production | Sheet 7 | 0.076 | A | 0.709 | 0.929 | 0.783 | 139.9 | 263 | 91 | 2.9 | 0.96 | 3.0 |
| Example 7 | | | | | | | | | | | | |
| Production | Sheet 8 | 0.011 | AA | 0.064 | 0.093 | 0.080 | 139.9 | 256 | 88 | 2.9 | 0.96 | 3.0 |
| Example 8 | | | | | | | | | | | | |
| Production | Sheet 9 | 0.067 | A | 0.175 | 0.349 | 0.236 | 138.0 | 239 | 82 | 1.2 | 0.43 | 2.9 |
| Example 9 | | | | | | | | | | | | |
| Production | Sheet 10 | 0.124 | B | 0.401 | 0.732 | 0.575 | 140.3 | 229 | 79 | 3.5 | 1.1 | 3.1 |
| Example 10 | | | | | | | | | | | | |
| Production | Sheet 11 | 0.026 | AA | 0.277 | 0.341 | 0.307 | 133.1 | 129 | 44 | 0.16 | 0.067 | 2.4 |
| Example 11 | | | | | | | | | | | | |
| Production | No sheet | — | — | — | — | — | 140.0 | 255 | 88 | 3.1 | 1.0 | 3.0 |
| Example 12 | formation | | | | | | | | | | | |

As shown in Table 2, the sheets 1 to 11 obtained by the production methods described in Production Examples 1 to 11 were each a polyolefin sheet having excellent film thickness uniformity. In addition, it was confirmed that in each of the sheets 1 to 11 obtained by the production methods described in Production Examples 1 to 11, the molecular weight distribution index (Mw/Mn) is from 2.4 to 3.2 and is low. The low molecular weight distribution index (Mw/Mn) is presumably due to being synthesized by a metallocene catalyst.

Among the sheets 1 to 11 obtained by the production methods described in Production Examples 1 to 11, the sheets 1 to 10 obtained by the production methods described in Production Examples 1 to 10 had only one melting peak, and in the sheets 1 to 10, the temperature of the melting peak was 138° C. or more but less than 145° C., and the crystallinity calculated by dividing the melting heat obtained from the area of the melting peak by the melting heat of the polyethylene perfect crystal was 65% or more. The sheets 1 to 10 correspond to the ultra-high molecular weight polyethylene sheet according to the present disclosure because of containing an ultra-high molecular weight polyethylene in an amount of 50 mass % or more with respect to a total mass of the ultra-high molecular weight polyethylene sheet, the ultra-high molecular weight polyethylene having a weight average molecular weight of 500,000 or more estimated from a molecular weight distribution curve of a contained polyethylene obtained by carrying out a gel permeation chromatography (GPC) measurement at 150° C. using 1,2,4-trichlorobenzene as an eluent.

### Production of Polyethylene Sheet

### Production Example 13

A commercially available polymer powder of ultra-high molecular weight polyethylene [product name: HI-ZEX MILLION® 340 M, melting point: 140° C., manufactured by Mitsui Chemicals, Inc.] was roll-pressed so that a sheet was discharged at a rate of 3 m/min from between a pair of rolls held at a temperature of 140° C. Thus, a polyethylene sheet 13 (also referred to as a “sheet 13”) was obtained.

The film thickness of the obtained sheet 13 was measured by the method described in “1. Film thickness” of [Evaluation (1)] described above. As a result, the average film thickness of the sheet 13 was 100 μm.

### Production Example 14

A commercially available polymer powder of ultra-high molecular weight polyethylene [product name: HI-ZEX MILLION® 340 M, melting point: 140° C., manufactured by Mitsui Chemicals, Inc.] was sandwiched between upper and lower press mechanisms installed in a desktop press device (manufactured by TESTER SANGYO CO, LTD.), and held at 180° C., which was equal to or higher than the melting point of the polymer powder of ultra-high molecular weight polyethylene, for 5 minutes, then melt-press-molded at a pressure of 2.5 MPa (cylinder pressure: 30 MPa), and then cooled to room temperature and taken out. Thus, a polyethylene sheet 14 (also referred to as a “sheet 14”) was obtained.

The film thickness of the obtained sheet 14 was measured by the method described in “1. Film thickness” of [Evaluation (1)] described above. As a result, the average film thickness of the sheet 14 was 300 μm.

### Production Example 15

The same operation as in Production Example 13 was carried out to obtain a sheet 13. The obtained sheet 13 was cut into a square of 5 cm×5 cm. The cut sheet was fixed by eight chucks in total of four corners and parallel and perpendicular four directions of a planar extension stretching machine [manufactured by Island Industry Co., Ltd.], and then heated to 150° C. and held for 5 minutes, and then simultaneously and biaxially stretched at a rate of 20 mm/min to a stretch ratio of 6 times×6 times. Thereafter, the biaxially stretched film was taken out after cooling to room temperature. Thus, a polyethylene sheet 15 (also referred to as a “sheet 15”) was obtained.

The film thickness of the obtained sheet 15 was measured by the method described in “1. Film thickness” of [evaluation (1)] described above. As a result, the average film thickness of the sheet 15 was 8 μm.

### Evaluation (2)

The following evaluations were carried out for the polyethylene sheets (that is, the sheets 13 to 15) obtained by the production methods described in Production Examples 13 to 15. In addition, for the polyethylene sheets (that is, the sheets 1, 2, and 11) obtained by the production methods described in Production Examples 1, 2, and 11, the following evaluations other than those already carried out (that is, DSC measurement and molecular weight measurement) were carried out.

### 1. DSC Measurement

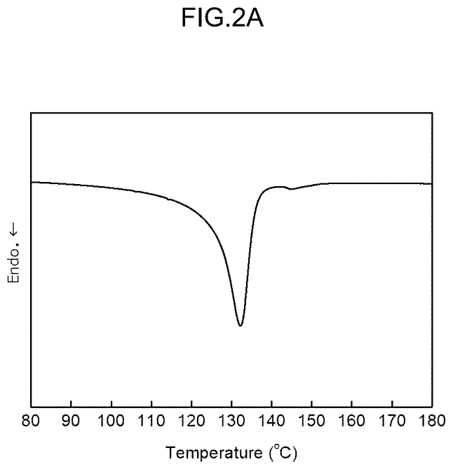

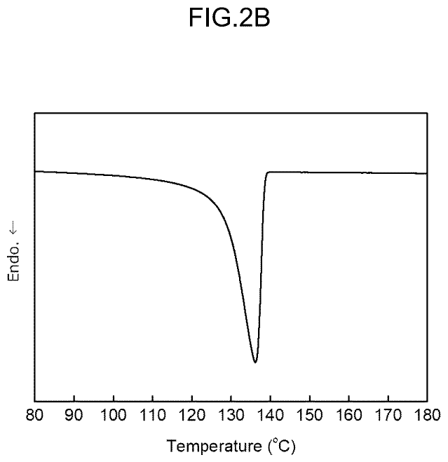

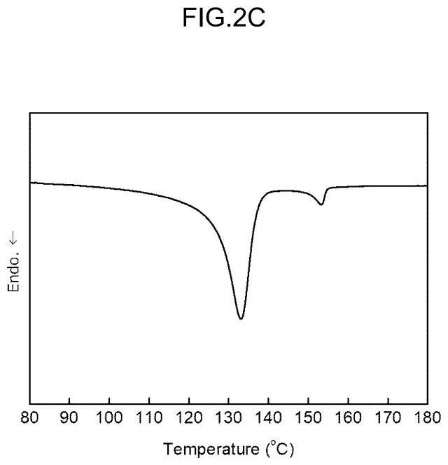

The same operation as in “2. DSC measurement” of [Evaluation (1)] described above was carried out to obtain the melting peak temperature (Tpm), the melting heat obtained from the area of the melting peak, and the crystallinity of the polyethylene sheets (that is, the sheets 13 to 15). The results are shown in Table 3. The DSC curves of the sheets 13, 14, and 15 are shown in FIGS. 2A, 2B, and 2C, respectively.

### 2. Molecular Weight Measurement

The same operation as in “3. Molecular weight measurement” of [Evaluation (1)] described above was carried out to measure the weight average molecular weight (Mw) and the number average molecular weight (Mn) of the polyethylenes contained in the polyethylene sheets (that is, the sheets 13 to 15). The molecular weight distribution index (Mw/Mn) was obtained from the measured weight average molecular weight (Mw) and number average molecular weight (Mn). The results are shown in Table 3.

### 3. Tear Strength

The polyethylene sheet was cut into a strip of 40 mm (length)×25 mm (width) to obtain a test piece. In the central part in the width direction of the test piece, an incision of 20 mm was made parallel to the length direction, two opposite ends of the test piece with the incision were held by the upper and lower chucks of a TENSILON universal testing machine (model number: RTC-1325A) manufactured by ORIENTEC CORPORATION, the remaining 20 mm of the test piece, in which no incision was made, was pulled up and down at a rate of 200 mm/min under an environment at an ambient temperature of 25° C., and the maximum stress when tearing the test piece was recorded. The value obtained by dividing the recorded maximum stress by the average film thickness of the test piece was defined as the tear strength. In this regard, the average film thickness of the test piece was calculated by assuming that the true density of the polyethylene in the polyethylene sheet was 1.000 g/cm³, and by dividing the mass of the test piece by the length of the test piece and the width of the test piece. Specifically, the average film thickness of the test piece was obtained by the following calculation formula. The results are shown in Table 3.

$$“ average film thickness ( mm ) of test piece ” = “ mass ( mg ) of test piece ” \text{} / ( “ length ( mm ) of test piece ” \times “ width ( mm ) of test piece ” )$$

When the test piece was cut out from the sheet 1, the sheet 2, or the sheet 11, the tear strength when the test piece was cut out such that the direction parallel to the rotation direction of the container used during production was the length direction was defined as the “tear strength in the parallel direction”, and the tear strength when the test piece was cut out such that the direction perpendicular to the rotation direction of the container was the length direction was defined as the “tear strength in the perpendicular direction”.

Meanwhile, when the test piece was cut out from the sheet 13, the tear strength when the test piece was cut out such that the direction parallel to the roll-pressing direction was the length direction was defined as the “tear strength in the parallel direction”, and the tear strength when the test piece was cut out such that the direction perpendicular to the roll-pressing direction was the length direction was defined as the “tear strength in the perpendicular direction”.

Regarding the sheet 14 and the sheet 15, since they are an unstretched sheet (sheet 14) or a sheet (sheet 15) having the same stretch ratios in the longitudinal direction and the width direction, there is no distinction between parallel and perpendicular directions.

### 4. Tensile Breaking Strength

The polyethylene sheet was cut into a size of 30 mm (length; initial length)×5 mm (width) to obtain a test piece. The test piece was subjected to a tensile test at a stretching rate of 20 mm/min under an environment at an ambient temperature of 25° C. using a TENSILON universal testing machine (model number: RTC-1325A) manufactured by ORIENTEC CORPORATION as a measurement apparatus. The test piece was pulled in the length direction. The value obtained by dividing the maximum stress of the recorded stress chart by the cross-sectional area of the test piece was defined as the tensile breaking strength. The cross-sectional area of the test piece was calculated by assuming that the true density of the polyethylene in the polyethylene sheet was 1.000 g/cm³, and by dividing the mass of the test piece by the length of the test piece. Specifically, the cross-sectional area of the test piece was obtained by the following calculation formula. The results are shown in Table 3.

$$“ cross ‐ sectional area ( {mm}^{2} ) of test piece ” = “ mass ( mg ) of test piece ” / “ length ( mm ) of test piece ”$$

When the test piece was cut out from the sheet 1, the sheet 2, or the sheet 11, the tensile breaking strength when the test piece was cut out such that the direction parallel to the rotation direction of the container used in production was the length direction was defined as the “tensile breaking strength in the parallel direction”, and the tensile breaking strength when the test piece was cut out such that the direction perpendicular to the rotation direction of the container was the length direction was defined as the “tensile breaking strength in the perpendicular direction”.

Meanwhile, when the test piece was cut out from the sheet 13, the tensile breaking strength when the test piece was cut out such that the direction parallel to the roll-pressing direction was the length direction was defined as the “tensile breaking strength in the parallel direction”, and the tensile breaking strength when the test piece was cut out such that the direction perpendicular to the roll-pressing direction was the length direction was defined as the “tensile breaking strength in the perpendicular direction”.

Regarding the sheet 14 and the sheet 15, since they are an unstretched sheet (sheet 14) or a sheet (sheet 15) having the same stretch ratios in the longitudinal direction and the width direction, there is no distinction between parallel and perpendicular directions.

### 5. Degree of Orientation

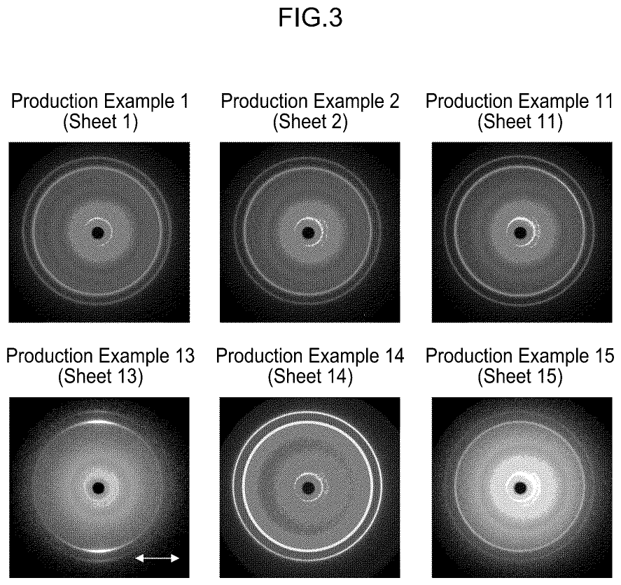

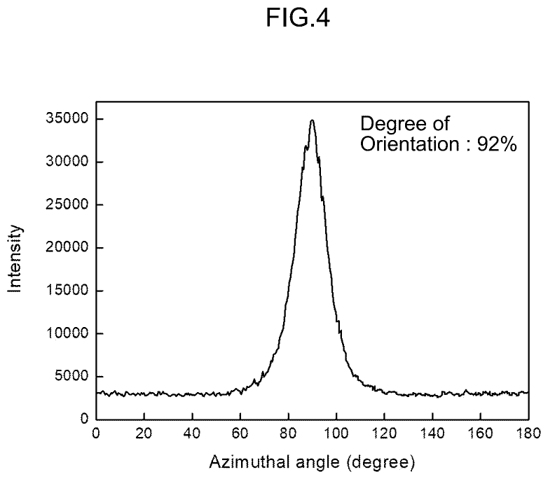

A WAXD (Wide Angle X-ray Diffraction) image (two-dimensional diffraction image) was obtained by normal incident X-rays on a polyethylene sheet surface using an X-ray measurement apparatus (a combination of an X-ray generator (model number: MicroMaX007/HF) manufactured by Rigaku Holdings Corporation, an image intensifier (model number: V7739) manufactured by Hamamatsu Photonics K.K., and a CCD camera (model number: C4742-98) manufactured by Hamamatsu Photonics K.K.). The degree of orientation of the polyolefin sheet was calculated according to the following formula from the peak full-width at half maximum (FWHM) of the azimuthal angle profile obtained by scanning the orthorhombic (110) reflection intensity of the obtained diffraction image in the azimuthal angle direction. In this regard, when the azimuthal angle profile was flat and no peak was recognized, the degree of orientation was regarded as 0%. The results are shown in Table 3. The WAXD images obtained at the time of measurement were shown in FIG. 3. Also, a graph showing the azimuthal angle profile of the sheet 13 is shown in FIG. 4.

$$Degree of orientation ( \% ) = \{ ( 180 ° - FWHM [ ° ] ) / 180 ° \} \times 100$$

### 6. Contact Angle

The polyethylene sheet was cut into a circular shape having a diameter of 1 cm to obtain a test piece. The test piece was fixed to a contact angle meter (model number: DropMaster100) manufactured by Kyowa Interface Science Co., Ltd. A water droplet was formed at the tip of the needle of the syringe mounted on the contact angle meter, and the height of the stage was adjusted to bring the test piece close to the formed water droplet. When the water droplet came into contact with the test piece, the stage was lowered to attach the droplet onto the test piece. In this state, the droplet and the test piece were observed from the side through a magnifying lens, whereby the contact angle was measured. The measurement was carried out under an environment at an ambient temperature of 25° C. In this regard, for the sheet 11, unevenness of the same degree (several mm) as the water droplet size was present on the surface of the test piece, and it was impossible to carry out the measurement of the contact angle by the 0/2 method. The results are shown in Table 3.

### 7. Dimensional Change

The polyethylene sheet was cut into a 3-cm square such that each side was parallel or perpendicular to the rotation direction of the container to obtain a test piece. The test piece was charged into an oil bath held at 140° C., and taken out after a lapse of 10 minutes, and the displacement from the original length 3 cm was measured. The dimensional change rate (%) was calculated by dividing the measured displacement by the original length 3 cm.

Here, in the case in which the displacement from the original length 3 cm by heating is a positive value, it means that the polyethylene sheet expands with respect to the measurement direction of the displacement, and in the case in which the displacement is a negative value, it means that the sheet shrinks with respect to the measurement direction of the displacement. Therefore, in the former case, it is desirable that the dimensional change rate, which is a positive value, is smaller, and in the latter case, it is desirable that the dimensional change rate, which is a negative value, is larger. That is, it is desirable that the dimensional change rate is closer to 0. In order to numerically define this, in the present disclosure, the absolute value of the dimensional change rate was used. The results are shown in Table 3.

For the sheets 1, 2, and 11, the dimensional change rate in the parallel direction with respect to the rotation direction of the container and the dimensional change rate in the perpendicular direction with respect to the rotation direction of the container were measured.

Meanwhile, for the sheet 13, the dimensional change rate in the parallel direction with respect to the roll-pressing direction and the dimensional change rate in the perpendicular direction with respect to the roll-pressing direction were measured. Regarding the sheet 14 and the sheet 15, since they are an unstretched sheet (sheet 14) or a sheet (sheet 15) having the same stretch ratios in the longitudinal direction and the width direction, there is no distinction between parallel and perpendicular directions.

### 8. Scanning Electron Microscope (SEM) Observation

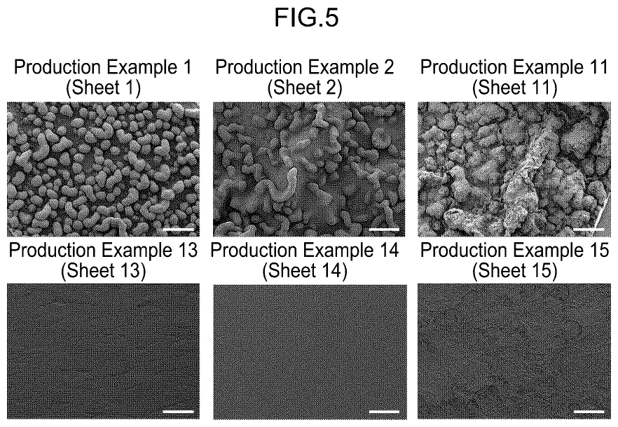

The polyethylene sheet was cut into a circular shape having a diameter of 1 cm to obtain a test piece. On the test piece, an ion sputter (model number: E1045) manufactured by Hitachi High-Tech Corporation. was used to form a platinum palladium vapor deposition coating having a thickness of 0.5 nm. The observation of the test piece having the vapor deposition coating was carried out at an acceleration voltage of 1 kV using a field emission type scanning electron microscope (FS-SEM) manufactured by Hitachi High-Tech Corporation. The SEM images obtained by the observation are shown in FIG. 5. The scale bar described in FIG. 5 indicates 500 μm.

In the sheets 1, 2, and 11, the rotation direction of the container is the lateral direction of the SEM image. In the sheet 13, the roll-pressing direction is the lateral direction of the SEM image. Regarding the sheet 14 and the sheet 15, since they are an unstretched sheet (sheet 14) or a sheet (sheet 15) having the same stretch ratios in the longitudinal direction and the width direction, there is no distinction between parallel and perpendicular directions.

TABLE 3

| | | | | | | | | Tear strength | | |
|---|---|---|---|---|---|---|---|---|---|---|
| | | DSC measurement | | | Molecular weight | | | [N/mm] | | |
| | | | Melting | | measurement | | | | | Parallel |
| | | Tpm | heat | Crystallinity | Mw | Mn | Mw/ | Parallel | Perpendicular | direction/perpendicular |
| | | [° C.] | [J/g] | [%] | [×10⁶] | [×10⁶] | Mn | direction | direction | direction |
| Production | Sheet 1 | 140.1 | 258 | 89 | 3.1 | 1.0 | 3.0 | 31.3 | 24.1 | 1.3 |
| Example 1 | | | | | | | | | | |
| Production | Sheet 2 | 138.0 | 231 | 80 | 1.5 | 0.51 | 29. | 30.2 | 27.6 | 1.1 |
| Example 2 | | | | | | | | | | |
| Production | Sheet 11 | 133.1 | 129 | 44 | 0.16 | 0.067 | 2.4 | 3.4 | 4.9 | 0.70 |
| Example 11 | | | | | | | | | | |
| Production | Sheet 13 | (1) 132.2 | 165 | 57 | 1.8 | 0.23 | 7.8 | 3.4 | 7.5 | 2.2 |
| Example 13 | | (2) 145.1 | | | | | | | | |
| Production | Sheet 14 | 136.2 | 166 | 57 | 1.8 | 0.23 | 7.8 | 39.3 | 41.3 | 1.0 |
| Example 14 | | | | | | | | | | |
| Production | Sheet 15 | (1) 133.1 | 168 | 58 | 1.8 | 0.23 | 7.8 | 5.4 | 5.7 | 0.95 |
| Example 15 | | (2) 153.3 | | | | | | | | |

| | Tensile breaking strength | | | | | | |
|---|---|---|---|---|---|---|---|
| | [Mpa] | | | | | Absolute value of | |
| | | | Parallel | | | dimensional change rate | |
| | | | direction/ | Degree of | | [%] | |
| | Parallel | Perpendicular | perpendicular | orientation | Contact angle | Parallel | Perpendicular |
| | direction | direction | direction | [%] | [°] | direction | direction |
| Production | 6.6 | 6.2 | 1.1 | 0 | 128.4 | 1.8 | 9.3 |
| Example 1 | | | | | | | |
| Production | 5.9 | 7.0 | 0.84 | 0 | 121.8 | 6.4 | 8.6 |
| Example 2 | | | | | | | |
| Production | 2.5 | 2.0 | 1.3 | 0 | un- | 8.7 | 5.4 |
| Example 11 | | | | | measurable | | |
| Production | 124.5 | 15.5 | 8.0 | 92 | 88.2 | 15.3 | 71.3 |
| Example 13 | | | | | | | |
| Production | 31.5 | 28.1 | 1.1 | 0 | 84.4 | 8.9 | 7.9 |
| Example 14 | | | | | | | |
| Production | 87.3 | 59.6 | 1.5 | 0 | 90.2 | 52.8 | 51.9 |
| Example 15 | | | | | | | |

As shown in Table 3, each of the sheets 13, 14, and 15 contained an ultra-high molecular weight polyethylene in an amount of 50 mass % or more with respect to a total mass of the ultra-high molecular weight polyethylene sheet, the ultra-high molecular weight polyethylene having a weight average molecular weight of 500,000 or more estimated from a molecular weight distribution curve of a contained polyethylene obtained by carrying out a gel permeation chromatography (GPC) measurement at 150° C. using 1,2,4-trichlorobenzene as an eluent.

However, as shown in Table 3 and FIG. 2A, the sheet 13 had two melting peaks (132.2° C. and 145.1° C.) and had a crystallinity of less than 65% (57%). Further, as shown in Table 3 and FIG. 2B, the sheet 14 had only one melting peak, but had a melting peak temperature of less than 138° C. (136.2° C.) and a crystallinity of less than 65% (57%). Furthermore, as shown in Table 3 and FIG. 2C, the sheet 15 had two melting peaks (133.1° C. and 153.3° C.) and a crystallinity of less than 65% (58%).

Therefore, each of the sheets 13, 14, and 15 does not correspond to the ultra-high molecular weight polyethylene sheet according to the present disclosure. Among the two circular rings in each WAXD image shown in FIG. 3, the inner ring is an orthorhombic (110) reflection, and the outer ring is an orthorhombic (200) reflection. With regard to the inner ring, the intensity profile obtained by cutting the orthorhombic (110) reflection in the azimuthal angle direction along the circular ring was recorded. Regarding the sheets 1, 2, 11, 14, and 15, since the profile was flat and no peak was recognized, the degree of orientation was regarded as 0% as shown in Table 3. On the other hand, as shown in FIG. 4, regarding the sheet 13, a clear peak was recognized. The left-right direction of the WAXD image of FIG. 3 corresponds to 0° and 180° of the azimuthal angle profile of FIG. 4. The degree of orientation of the sheet 13 calculated using the above formula from the FWHM of the azimuthal angle profile was 92% as shown in Table 3.

In the sheet 13, the direction (roll-pressing direction) in which the sheet is discharged is indicated by an arrow.

As shown in FIG. 5, the surfaces of the sheets 1 and 2, which were ultra-high molecular weight polyethylene sheets according to the present disclosure, had a surface structure having worm-like (earthworm-like) and/or spherical protrusions with a diameter (width) of about 150 μm. Regarding the sheets 1 and 2, the ratio of the total area of the worm-like and spherical protrusions present on the surface of the sheet to the surface area of the sheet (the total area of the worm-like and spherical protrusions present on the surface of the sheet/the surface area of the sheet) was confirmed to be from 30% to 70%. The total area of the worm-like and spherical protrusions present on the surface of the sheet was calculated from the SEM image shown in FIG. 5. In this regard, the lengths of the worm-like (earthworm-like) protrusions were at most about 1000 μm.

As shown in Table 3, it was clarified that the sheets 1 and 2, which are ultra-high molecular weight polyethylene sheets according to the present disclosure, have a high tear strength. It is considered that since the ultra-high molecular weight polyethylene sheet according to the present disclosure has no molecular orientation such as that of a stretched film, the tear strength is high. In addition, it was confirmed that the ultra-high molecular weight polyethylene sheet according to the present disclosure is characterized in that it has no anisotropy in molecular orientation in the sheet surface direction and is less tearable in any direction.

It was clarified that the sheets 1 and 2, which are ultra-high molecular weight polyethylene sheets according to the present disclosure, also have a high tensile breaking strength. It was confirmed that also regarding the tensile breaking strength, the sheets exhibit uniform performance in the sheet surface direction. These results indicate that the ultra-high molecular weight polyethylene sheet according to the present disclosure is suitable for a protective film, which is one of industrial applications of ultra-high molecular weight polyethylene sheets.

It was clarified that the sheets 1 and 2, which are ultra-high molecular weight polyethylene sheets according to the present disclosure, have little dimensional change even when heated to 140° C., which is equal to or higher than the melting point. It is considered that since the ultra-high molecular weight polyethylene sheet according to the present disclosure has no molecular orientation such as that of a stretched film, dimensional change is unlikely to occur. From this result, it can be said that the ultra-high molecular weight polyethylene sheet according to the present disclosure is a sheet material having high heat resistance, and it is considered that the sheet can withstand sterilization treatment at high temperatures or the like.

In contrast, a remarkable dimensional change was confirmed in stretched films such as the sheet 13, which is a roll-pressed film, and the sheet 15, which is a melt biaxially stretched film, and it was clarified that stretched films have a problem in heat resistance. It was clarified that the sheets 1 and 2, which are ultra-high molecular weight polyethylene sheets according to the present disclosure, have a large water contact angle and exhibit an extremely high water repellency. As shown in FIG. 5, it can be seen that the sheets 1 and 2 have worm-like and/or spherical protrusions on the surface of the sheet. It is considered that owing to having such a specific surface structure, the sheets 1 and 2 exhibit extremely high water repellency. It is presumed that such a surface structure of the sheets 1 and 2 is caused by structural formation in the polymerization process. It was confirmed that the surface structure of the sheets 1 and 2 is extremely different from the sheet 13, which is a roll-pressed film and has a smooth surface structure, the sheet 14, which is a melt-pressed film, and the sheet 15, which is a melt-biaxially-stretched film.

The disclosure of Japanese Patent Application No. 2022-082564, filed on May 19, 2022, is incorporated herein by reference in its entirety.

All publications, patent applications, and technical standards mentioned in this specification are herein incorporated by reference to the same extent as if each individual publication, patent application, or technical standard was specifically and individually indicated to be incorporated by reference.

1. A method for producing a polyolefin sheet, the method comprising:
a step A of applying an organic solvent containing a metal catalyst onto an inner wall surface of a container; and
a step B of synthesizing a polyolefin on the inner wall surface of the container by introducing an olefin monomer into the container, in which the organic solvent containing a metal catalyst has been applied onto the inner wall surface,
wherein, in the step A, the organic solvent containing a metal catalyst is applied onto the inner wall surface of the container by moving the container.

2. The method for producing a polyolefin sheet according to claim 1, wherein, in the step A, the organic solvent containing a metal catalyst is applied onto the inner wall surface of the container by rotating the container.

3. The method for producing a polyolefin sheet according to claim 1, wherein the metal catalyst is at least one selected from the group consisting of metallocene complexes, phenoxyimine titanium complexes, phenoxyimine zirconium complexes, phenoxyimine hafnium complexes, cyclopentadienylquinolyl chromium complexes, diimine palladium complexes, diimine nickel complexes, bisiminopyridine iron complexes, and bisiminopyridine cobalt complexes.

4. The method for producing a polyolefin sheet according to claim 1, wherein the organic solvent containing a metal catalyst further contains a co-catalyst.

5. The method for producing a polyolefin sheet according to claim 4, wherein the co-catalyst is at least one selected from the group consisting of an alkylaluminoxane, a dialkylaluminum chloride, a trialkylaluminum/triphenylmethylium tetrakis(pentafluorophenyl)borate, a trialkylaluminum/N,N-dimethylanilinium tetrakis(pentafluorophenyl)borate, a trialkylaluminum/tris(pentafluorophenyl)borane, and sodium tetrakis(3,5-bis(trifluoromethyl)phenyl)borate.

6. The method for producing a polyolefin sheet according to claim 1, wherein, a viscosity at 20° C. of the organic solvent containing a metal catalyst is 0.1 mPa·s or more but 10,000 mPa·s or less.

7. The method for producing a polyolefin sheet according to claim 1, wherein, in the step B, the olefin monomer is introduced in a gas or liquid state.

8. The method for producing a polyolefin sheet according to claim 1, wherein the olefin monomer is at least one selected from the group consisting of ethylene, propylene, 1-butene, 1-pentene, 1-hexene, 1-octene, 1-nonene, 1-decene, 4-methyl-1-pentene, cyclopentene, norbornene, styrene, vinylcyclohexane, allylcyclohexane, 4-cyclohexyl-1-butene, 5-cyclohexyl-1-pentene, 6-cyclohexyl-1-hexene, and tert-butylethylene.

9. The method for producing a polyolefin sheet according to claim 1, wherein, in the step B, as the olefin monomer, a monomer containing ethylene in an amount of 50 mass % or more with respect to a total mass of the monomer is introduced into the container, in which the organic solvent containing a metal catalyst has been applied onto the inner wall surface, thereby synthesizing, on the inner wall surface of the container, an ultra-high molecular weight polyethylene having a weight average molecular weight of 500,000 or more estimated from a molecular weight distribution curve of a contained polyethylene obtained by carrying out a gel permeation chromatography measurement at 150° C. using 1,2,4-trichlorobenzene as an eluent.

10. An ultra-high molecular weight polyethylene sheet, comprising an ultra-high molecular weight polyethylene in an amount of 50 mass % or more with respect to a total mass of the ultra-high molecular weight polyethylene sheet, the ultra-high molecular weight polyethylene having a weight average molecular weight of 500,000 or more estimated from a molecular weight distribution curve of a contained polyethylene obtained by carrying out a gel permeation chromatography measurement at 150° C. using 1,2,4-trichlorobenzene as an eluent, wherein:
the ultra-high molecular weight polyethylene sheet has only one melting peak in a measurement by a differential scanning calorimeter;
a temperature of the melting peak is 138° C. or more but less than 145° C.; and
a crystallinity calculated by dividing a melting heat obtained from an area of the melting peak by a melting heat of a polyethylene perfect crystal is 65% or more.

11. The ultra-high molecular weight polyethylene sheet according to claim 10, wherein a molecular weight distribution index of the ultra-high molecular weight polyethylene is 5 or less.

12. The ultra-high molecular weight polyethylene sheet according to claim 10, wherein a degree of orientation estimated from an orthorhombic (110) reflection intensity of a diffraction image obtained by normal incident X-rays on a sheet surface is 50% or less.

13. The ultra-high molecular weight polyethylene sheet according to claim 10, wherein a tear strength is 20 N/mm or more.

14. The ultra-high molecular weight polyethylene sheet according to claim 10, wherein a water contact angle at 25° C. is 100° or more.

15. The ultra-high molecular weight polyethylene sheet according to claim 10, wherein, when heated at 140° C. for 10 minutes, an absolute value of a dimensional change rate in a parallel direction with respect to a sheet surface is less than 20%.
